(19) United States
(12) Patent Application Publication
(10) Pub. No.: US 2013/0104085 A1
(43) Pub. Date: Apr. 25, 2013

(54) SYSTEMS AND METHODS FOR HUMAN-COMPUTER INTERACTION USING A TWO HANDED INTERFACE

(71) Applicants: Paul Mlyniec, Los Gatos, CA (US); Jason Jerald, San Jose, CA (US); Arun Yoganandan, Campbell, CA (US)

(72) Inventors: Paul Mlyniec, Los Gatos, CA (US); Jason Jerald, San Jose, CA (US); Arun Yoganandan, Campbell, CA (US)

(73) Assignee: DIGITAL ARTFORMS, INC., Los Gatos, CA (US)

(21) Appl. No.: 13/279,226

(22) Filed: Oct. 21, 2011

(51) Int. Cl. G06F 3/048

(52) U.S. Cl. 715/849

(57) ABSTRACT

Certain embodiments relate to systems and methods for navigating and analyzing portions of a three-dimensional virtual environment using a two-handed interface. Particularly, methods for operating a Volumetric Selection Object (VSO) to select elements of the environment are provided, as well as operations for adjusting the user's position, orientation and scale. Efficient and ergonomic methods for quickly acquiring and positioning, orienting, and scaling the VSO are provided. Various uses of the VSO, such as augmenting a primary dataset with data from a secondary dataset are also provided.

### TECHNICAL FIELD

The systems and methods disclosed herein relate generally to human-computer interaction, particularly a user's control and navigation of a 3D environment using a two-handed interface.

### BACKGROUND

Various systems exist for interacting with a computer system. For simple 2-dimensional applications and for even certain three-dimensional applications, a single-handed interface such as a mouse may be suitable. For more complicated three-dimensional datasets, however, certain prior art suggests using a two-handed interface (THI) to select items and to navigate in a virtual environment. THI generally comprises a computer system facilitating user interaction with a virtual universe via gestures with each of the user's hands. An example of one THI system is provided in Mapes/Moshell in the 1995 issue of Presence (Daniel P. Mapes, J. Michael Moshell: A Two Handed Interface for Object Manipulation in Virtual Environments. Presence 4(4): 403-416 (1995)). This and other prior systems provide some concepts for using THI to navigate three-dimensional environments. For example, Ulinski's prior systems affix a selection primitive to a corner of the user's hand, aligned along the hand's major axis (Ulinski, A. “Taxonomy and Experimental Evaluation of Two-Handed Selection Techniques for Volumetric Data.”, Ph.D. Dissertation, University of North Caroline at Charlotte, 2008). Unfortunately, these implementations may be cumbersome for the user and fail to adequately consider the physical limitations imposed by the user's body and by the user's surroundings. Accordingly, there is a need for more efficient and ergonomic selection and navigation operations for a two handed interface in a virtual environment.

### SUMMARY

Certain embodiments contemplate a method for positioning, reorienting, and scaling a visual selection object (VSO) within a three-dimensional scene. The method may comprise receiving an indication of snap functionality activation at a first timepoint; determining a vector between a first and a second cursor; determining an attachment point on the first cursor; determining a translation and rotation of the first cursor. The method may also comprise translating and rotating the VSO to be aligned with the first cursor such that: a first face of the VSO is adjacent to the attachment point of the first cursor; and the VSO is aligned relative to the vector, wherein the method is implemented on one or more computer systems.

In some embodiments, the VSO is aligned relative to the vector comprises the longest axis of the VSO being parallel with the vector. In some embodiments, determining an attachment point on the first cursor comprises determining the center of the first cursor. In some embodiments, receiving a change in position and orientation associated with the first cursor from the first position and orientation to a second position and orientation and maintaining the relative translation and rotation of the VSO. In some embodiments, the method further comprises: receiving an indication to perform a scaling operation; determining an offset between an element of the VSO and the second cursor; and scaling the VSO based on the attachment point, offset, and second cursor position. In some embodiments, the element comprises one of a vertex, face, or edge of the VSO. In some embodiments, the element is a vertex and the scaling of the VSO is performed in three dimensions. In some embodiments, the element is an edge and the scaling of the VSO is performed in two dimensions. In some embodiments, the element is a face and the scaling of the VSO is performed in one dimension. In some embodiments, the method further comprises: receiving an indication that scaling is to be terminated; receiving a change in translation and rotation associated with the first cursor from the second position and orientation to a third position and orientation; and maintaining the relative position and orientation of the VSO following receipt of the indication that scaling is to be terminated.

Certain embodiments contemplate a non-transitory computer-readable medium comprising instructions configured to cause one or more computer systems to perform the method comprising: receiving an indication of snap functionality activation at a first timepoint; determining a vector between a first and a second cursor; determining an attachment point on the first cursor; determining a translation and rotation of the first cursor. The method may further comprise translating and rotating the VSO to be aligned with the first cursor such that: a first face of the VSO is adjacent to the attachment point of the first cursor; and the VSO is aligned relative to the vector.

In some embodiments, the VSO is aligned relative to the vector comprises the longest axis of the VSO being parallel with the vector. In some embodiments, determining an attachment point on the first cursor comprises determining the center of the first cursor. In some embodiments, receiving a change in position and orientation associated with the first cursor from the first position and orientation to a second position and orientation and maintaining the relative translation and rotation of the VSO. In some embodiments, the method further comprises: receiving an indication to perform a scaling operation; determining an offset between an element of the VSO and the second cursor; and scaling the VSO based on the attachment point, offset, and second cursor position. In some embodiments, the element comprises one of a vertex, face, or edge of the VSO. In some embodiments, the element is a vertex and the scaling of the VSO is performed in three dimensions. In some embodiments, the element is an edge and the scaling of the VSO is performed in two dimensions. In some embodiments, the element is a face and the scaling of the VSO is performed in one dimension. In some embodiments, the method further comprises: receiving an indication that scaling is to be terminated; receiving a change in translation and rotation associated with the first cursor from the second position and orientation to a third position and orientation; and maintaining the relative position and orientation of the VSO following receipt of the indication that scaling is to be terminated.

Certain embodiments contemplate a method for repositioning, reorienting, and rescaling a visual selection object (VSO) within a three-dimensional scene. The method comprises: receiving an indication of nudge functionality activation at a first timepoint; determining a first position and orientation offset between the VSO and a first cursor, receiving a change in position and orientation associated with the first cursor's first position and orientation and its second position and orientation. The method may also comprise translating and rotating the VSO relative to the first cursor such that: the VSO maintains the first offset relative position and relative orientation to the first cursor in the second orientation as in the first orientation, wherein the method is implemented on one or more computer systems.

In some embodiments, determining a first element of the VSO comprises determining an element closest to the first cursor. In some embodiments, the element of the VSO comprises one of a vertex, face, or edge of the VSO. In some embodiments, the method further comprises: receiving an indication to perform a scaling operation; determining a second offset between a second element of the VSO and a second cursor; and scaling the VSO about the first element maintaining the second offset between the second element of the VSO and the position of the second cursor. In some embodiments, the second offset comprises a zero or non-zero distance. In some embodiments, the second element comprises a vertex and scaling the VSO based on the second offset and a position of the second cursor comprises modifying the contours of the VSO in each of three dimensions based on the second cursor's translation from a first position to a second position. In some embodiments, the second element comprises an edge and scaling the VSO based on the second offset and a position of the second cursor comprises modifying the contours of the VSO in the directions that are orthogonal to the direction of the edge based on the second cursor's translation from a first position to a second position. In some embodiments, the second element comprises a face and scaling the VSO based on the second offset comprises modifying the contours of the VSO in the direction orthogonal to the element based on the second cursor's translation from a first position to a second position. In some embodiments, the method further comprises receiving an indication to terminate the scaling operation; receiving a change in translation and rotation associated with the first cursor from the second position and orientation to a third position and orientation; and maintaining the first offset relative direction and relative rotation to the first cursor in the third position and orientation as in the first position and orientation. In some embodiments, a viewpoint of a viewing frustum is located within the VSO, the method further comprising adjusting a rendering pipeline based on the position and orientation and dimensions of the VSO. In some embodiments, the dimensions of the VSO facilitate full extension of a user's arms without cursors corresponding to hand interfaces in the user's left and right hands leaving the selection volume of the VSO. In some embodiments, determining a first offset between a first element of the VSO and a first cursor comprises receiving an indication from the user selecting the first element of the VSO from a plurality of elements associated with the VSO.

Certain embodiments contemplate a non-transitory computer-readable medium comprising instructions configured to cause one or more computer systems to perform the method comprising: receiving an indication of nudge functionality activation at a first timepoint; determining a first position and orientation offset between the VSO and a first cursor, receiving a change in position and orientation associated with the first cursor's first position and orientation and its second position and orientation. The method may also comprise translating and rotating the VSO relative to the first cursor such that: the VSO maintains the first offset relative position and relative orientation to the first cursor in the second orientation as in the first orientation.

In some embodiments, determining a first element of the VSO comprises determining an element closest to the first cursor. In some embodiments, the element of the VSO comprises one of a vertex, face, or edge of the VSO. In some embodiments, the method further comprises: receiving an indication to perform a scaling operation; determining a second offset between a second element of the VSO and a second cursor; and scaling the VSO about the first element maintaining the second offset between the second element of the VSO and the position of the second cursor. In some embodiments, the second offset comprises a zero or non-zero distance. In some embodiments, the second element comprises a vertex and scaling the VSO based on the second offset and a position of the second cursor comprises modifying the contours of the VSO in each of three dimensions based on the second cursor's translation from a first position to a second position. In some embodiments, the second element comprises an edge and scaling the VSO based on the second offset and a position of the second cursor comprises modifying the contours of the VSO in the directions that are orthogonal to the direction of the edge based on the second cursor's translation from a first position to a second position. In some embodiments, the second element comprises a face and scaling the VSO based on the second offset comprises modifying the contours of the VSO in the direction orthogonal to the element based on the second cursor's translation from a first position to a second position. In some embodiments, the method further comprises receiving an indication to terminate the scaling operation; receiving a change in translation and rotation associated with the first cursor from the second position and orientation to a third position and orientation; and maintaining the first offset relative direction and relative rotation to the first cursor in the third position and orientation as in the first position and orientation. In some embodiments, a viewpoint of a viewing frustum is located within the VSO, the method further comprising adjusting a rendering pipeline based on the position and orientation and dimensions of the VSO. In some embodiments, the dimensions of the VSO facilitate full extension of a user's arms without cursors corresponding to hand interfaces in the user's left and right hands leaving the selection volume of the VSO. In some embodiments, determining a first offset between a first element of the VSO and a first cursor comprises receiving an indication from the user selecting the first element of the VSO from a plurality of elements associated with the VSO.

Certain embodiments contemplate a method for selecting at least a portion of an object in a three-dimensional scene using a visual selection object (VSO), the method comprising: receiving a first plurality of two-handed interface commands associated with manipulation of a viewpoint in a 3D universe. The first plurality comprises: a first command associated with performing a universal rotation operation; a second command associated with performing a universal translation operation; a third command associated with performing a universal scale operation. The method further comprises receiving a second plurality of two-handed interface commands associated with manipulation of the VSO, the second plurality comprising: a fourth command associated with translating the VSO, wherein at least a portion of the object is subsequently located within a selection volume of the VSO following the first and second plurality of commands, the method implemented on one or more computer systems.

In some embodiments, the first command temporally overlaps the second command. In some embodiments, the steps of receiving the first, second, third, and fourth command occur within a three-second interval. In some embodiments, the third command temporally overlaps the fourth command. In some embodiments, the second plurality further comprises a fifth command to scale the VSO and a sixth command to rotate the VSO. In some embodiments, the method further comprises a third plurality of two-handed interface commands associated with manipulation of a viewpoint in a 3D universe and a fourth plurality of two-handed interface commands associated with manipulation of the VSO. In some embodiments, the first plurality of commands are received before the second plurality of commands, second plurality of commands are received before the third plurality of commands, and the third plurality of commands are received before the fourth plurality of commands. In some embodiments, the method further comprises determining a portion of objects located within the selection volume of the VSO; rendering the portion of the objects within the selection volume with a first rendering method; and rendering the portion of objects outside the selection volume with a second rendering method.

Certain embodiments contemplate a non-transitory computer-readable medium comprising instructions configured to cause one or more computer systems to perform the method comprising: receiving a first plurality of two-handed interface commands associated with manipulation of a viewpoint in a 3D universe, the first plurality comprising: a first command associated with performing a universal rotation operation; a second command associated with performing a universal translation operation; a third command associated with performing a universal scale operation. The method may further comprise receiving a second plurality of two-handed interface commands associated with manipulation of the VSO, the second plurality comprising: a fourth command associated with translating the VSO, wherein at least a portion of the object is subsequently located within a selection volume of the VSO following the first and second plurality of commands.

In some embodiments, the first command temporally overlaps the second command. In some embodiments, the steps of receiving the first, second, third, and fourth command occur within a three-second interval. In some embodiments, the third command temporally overlaps the fourth command. In some embodiments, the second plurality further comprises a fifth command to scale the VSO and a sixth command to rotate the VSO. In some embodiments, the method further comprises a third plurality of two-handed interface commands associated with manipulation of a viewpoint in a 3D universe and a fourth plurality of two-handed interface commands associated with manipulation of the VSO. In some embodiments, the first plurality of commands are received before the second plurality of commands, second plurality of commands are received before the third plurality of commands, and the third plurality of commands are received before the fourth plurality of commands. In some embodiments, the method further comprises determining a portion of objects located within the selection volume of the VSO; rendering the portion of the objects within the selection volume with a first rendering method; and rendering the portion of objects outside the selection volume with a second rendering method.

Certain embodiments contemplate a method for rendering a scene based on a volumetric selection object (VSO) positioned, oriented, and scaled about a user's viewing frustum, the method comprising: receiving an indication to fix the VSO to the viewing frustum; receiving a translation, rotation, and/or scale command from a first hand interface. The method may comprise updating a translation, rotation, and/or scale of the VSO based on: the translation, rotation, and/or scale command; and a relative position between the VSO and the viewing frustum; and adjusting a rendering pipeline based on the position, orientation and dimensions of the VSO. The method may be implemented on one or more computer systems.

In some embodiments, adjusting a rendering pipeline comprises removing portions of objects within the selection volume of the VSO from the rendering pipeline. In some embodiments, the dimensions of the VSO facilitate full extension of a user's arms without cursors corresponding to hand interfaces in the user's left and right hands leaving the selection volume of the VSO. In some embodiments, the scene comprises volumetric data to be rendered substantially opaque.

Certain embodiments contemplate a non-transitory computer-readable medium comprising instructions configured to cause one or more computer systems to perform the method comprising: receiving an indication to fix the VSO to the viewing frustum; receiving a translation, rotation, and/or scale command from a first hand interface. The method may comprise updating a translation, rotation, and/or scale of the VSO based on: the translation, rotation, and/or scale command; and a relative position between the VSO and the viewing frustum; and adjusting a rendering pipeline based on the position, orientation and dimensions of the VSO.

In some embodiments, adjusting a rendering pipeline comprises removing portions of objects within the selection volume of the VSO from the rendering pipeline. In some embodiments, the dimensions of the VSO facilitate full extension of a user's arms without cursors corresponding to hand interfaces in the user's left and right hands leaving the selection volume of the VSO. In some embodiments, the scene comprises volumetric data to be rendered substantially opaque.

Certain embodiments contemplate a method for rendering a secondary dataset within a volumetric selection object (VSO), the VSO located in a virtual environment in which a primary dataset is rendered. The method may comprise: receiving an indication of slicing volume activation at a first timepoint; determining a portion of one or more objects located within a selection volume of the VSO; retrieving data from the secondary dataset associated with the portion of the one or more objects; and rendering a sliceplane within the VSO, wherein at least one surface of the sliceplane depicts a representation of at least a portion of the secondary dataset. The method may also comprise receiving a rotation command from a first hand interface at a second timepoint following the first timepoint; and rotating and translating the sliceplane based on the rotation and translation command from the first hand interface. The method may be implemented on one or more computer systems.

In some embodiments, the secondary dataset comprises a portion of the primary dataset and wherein rendering a sliceplane comprises rendering a portion of secondary dataset in a manner different from a rendering of the primary dataset. In some embodiments, the secondary dataset comprises tomographic data different from the primary dataset. In some embodiments, the portion of the VSO within a first direction orthogonal to the sliceplane is rendered opaquely. In some embodiments, the portion of the VSO within a second direction opposite the first direction is rendered transparently. In some embodiments, the sliceplane depicts a cross-section of an object. In some embodiments, the method further comprises receiving a second position and/or rotation command from a second hand interface at the second timepoint, wherein rotating the sliceplane is further based on the second position and/or rotation command from the second hand interface.

Certain embodiments contemplate a non-transitory computer-readable medium comprising instructions configured to cause one or more computer systems to perform a method for rendering a secondary dataset within a volumetric selection object (VSO), the VSO located in a virtual environment in which a primary dataset is rendered. The method may comprise: receiving an indication of slicing volume activation at a first timepoint; determining a portion of one or more objects located within a selection volume of the VSO; retrieving data from the secondary dataset associated with the portion of the one or more objects; and rendering a sliceplane within the VSO, wherein at least one surface of the sliceplane depicts a representation of at least a portion of the secondary dataset. The method may also comprise receiving a rotation command from a first hand interface at a second timepoint following the first timepoint; and rotating and translating the sliceplane based on the rotation and translation command from the first hand interface. The method may be implemented on one or more computer systems.

In some embodiments, the secondary dataset comprises a portion of the primary dataset and wherein rendering a sliceplane comprises rendering a portion of secondary dataset in a manner different from a rendering of the primary dataset. In some embodiments, the secondary dataset comprises tomographic data different from the primary dataset. In some embodiments, the portion of the VSO within a first direction orthogonal to the sliceplane is rendered opaquely. In some embodiments, the portion of the VSO within a second direction opposite the first direction is rendered transparently. In some embodiments, the sliceplane depicts a cross-section of an object. In some embodiments, the method further comprises receiving a second position and/or rotation command from a second hand interface at the second timepoint, wherein rotating the sliceplane is further based on the second position and/or rotation command from the second hand interface.

### BRIEF DESCRIPTION OF THE DRAWINGS

FIG. 1 illustrates a general computer system arrangement which may be used to implement certain of the embodiments.

FIG. 2 illustrates a possible hand interface which may be used in certain of the embodiments to provide indications of the user's hand position and motion to a computer system.

FIG. 3 illustrates a possible 3D cursor which may be used in certain of the embodiments to provide the user with visual feedback concerning a position and rotation corresponding to the user's hand in a virtual environment.

FIG. 4 illustrates a relationship between user translation of the hand interface and translation of the cursor as implemented in certain of the embodiments.

FIG. 5 illustrates a relationship between a rotation of the hand interface and a rotation of the cursor as implemented in certain of the embodiments.

FIG. 6 illustrates a universal translation operation as performed by a user with one or more hand interfaces as implemented in certain of the embodiments, wherein the user moves the entire virtual environment, or conversely moves the viewing frustum, relative to one another.

FIG. 7 illustrates a universal rotation operation as performed by a user with one or more hand interfaces as implemented in certain of the embodiments, wherein the user rotates the entire virtual environment, or conversely rotates the viewing frustum, relative to one another.

FIG. 8 illustrates a universal scaling operation as performed by a user with one or more hand interfaces as implemented in certain of the embodiments, wherein the user scales the entire virtual environment, or conversely scales the viewing frustum, relative to one another.

FIG. 9 illustrates a relationship between translation and rotation operations of a hand interface and an object selected in the virtual environment as implemented in certain embodiments.

FIG. 10 illustrates a plurality of three-dimensional representations of a Volumetric Selection Object (VSO) which may be implemented in various embodiments.

FIG. 11 is a flow diagram depicting certain steps of a snap operation and snap-scale operation as implemented in certain embodiments.

FIG. 12 illustrates various relationships between a cursor and VSO during and following a snap operation.

FIG. 13 illustrates a VSO translation and orientation realignment operation between the VSO and the cursor during a snap operation as implemented in certain embodiments.

FIG. 14 illustrates another VSO translation and orientation realignment operation between the VSO and the cursor during a snap operation as implemented in certain embodiments.

FIG. 15 illustrates a VSO snap scaling operation as may be performed in certain embodiments.

FIG. 16 is a flow diagram depicting certain steps of a nudge operation and nudge-scale operation as may be implemented in certain embodiments.

FIG. 17 illustrates various relationships between the cursor and VSO during and following a nudge operation.

FIG. 18 illustrates aspects of a nudge scaling operation of the VSO as may be performed in certain embodiments.

FIG. 19 is a flow diagram depicting certain steps of various posture and approach operations as may be implemented in certain embodiments.

FIG. 20 is a flow diagram depicting the interaction between viewpoint and VSO adjustment as part of a posture and approach process in certain embodiments.

FIG. 21 illustrates various steps in a posture and approach operation as may be implemented in certain embodiments from the conceptual perspective of a user operating in a virtual environment.

FIG. 22 illustrates another example of a posture and approach operation as may be implemented in certain embodiments, wherein a user merges multiple discrete translation, scaling, and rotation operations in conjunction with a nudge operation to maneuver a VSO about a desired portion of an engine.

FIG. 23 is a flow diagram depicting certain steps in a VSO-based rendering operation as implemented in certain embodiments.

FIG. 24 illustrates certain effects of various VSO-based rendering operations applied to a virtual environment consisting of an apple containing apple seeds as implemented in certain embodiments.

FIG. 25 illustrates certain effects of various VSO-based rendering operations as applied to a virtual environment consisting of an apple containing apple seeds as implemented in certain embodiments.

FIG. 26 is a flow diagram depicting certain steps in a user-immersed VSO-based clipping operation as implemented in certain embodiments, wherein the viewing frustum is located within and may be attached or fixed to the VSO, while the VSO is used to determine clipping operations in the rendering pipeline.

FIG. 27 illustrates a user creating, positioning, and then maneuvering into a VSO clipping volume in a virtual environment consisting of an apple with apple seeds as may be implemented in certain embodiments, where the VSO clipping volume performs selective rendering.

FIG. 28 illustrates a user creating, positioning, and then maneuvering into a VSO clipping volume in a virtual environment consisting of an apple with apple seeds as may be implemented in certain embodiments, where the VSO clipping volume completely removes portions of objects within the selection volume, aside from the user's cursors, from the rendering pipeline.

FIG. 29 illustrates a conceptual physical relationship between a user and a VSO clipping volume as implemented in certain embodiments, wherein the user's cursors fall within the volume selection area so that the cursors are visible, even when the VSO is surrounded by opaque material.

FIG. 30 illustrates an example of a user maneuvering within a VSO clipping volume to investigate a seismic dataset for ore deposits as implemented in certain embodiments.

FIG. 31 illustrates a user performing an immersive nudge operation while located within a VSO clipping volume attached to the viewing frustum.

FIG. 32 is a flow diagram depicting certain steps performed in relation to the placement and activation of slicebox functionality in certain embodiments.

FIG. 33 is a flow diagram depicting certain steps in preparing and operating a VSO slicing volume function as implemented in certain embodiments.

FIG. 34 illustrates an operation for positioning and orienting a slicing plane within a VSO slicing volume using a single hand interface as implemented in certain embodiments.

FIG. 35 illustrates an operation for positioning and orienting a slicing plane within a VSO slicing volume using a left and a right hand interface as implemented in certain embodiments.

FIG. 36 illustrates an application of a VSO slicing volume to a tissue fold within a model of a patient's colon as part of a tumor identification procedure as implemented in certain embodiments.

FIG. 37 illustrates a plurality of alternative rendering methods for the VSO slicing volume as presented in the operation of FIG. 36, wherein the secondary dataset is presented within the VSO in a plurality of rendering methods to facilitate analysis by the user.

FIG. 38 illustrates certain further transparency rendering methods of the VSO slicing volume as implemented in certain embodiments to provide contextual clarity to the user.

### DETAILED DESCRIPTION

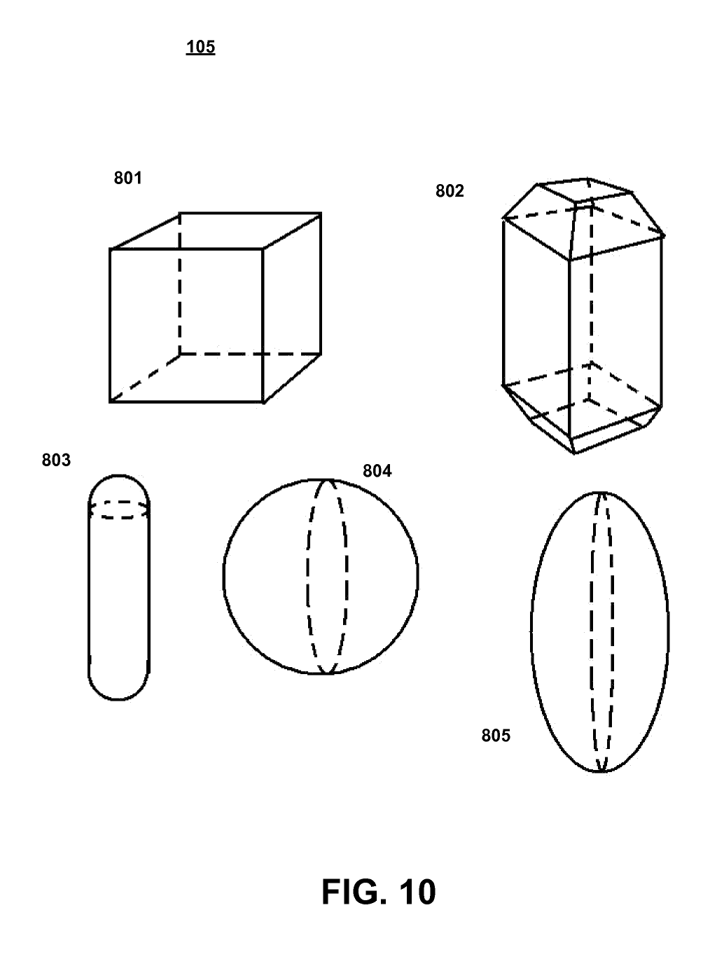

Unless indicated otherwise, terms as used herein will be understood to imply their customary and ordinary meaning. Visual Selection Object (VSO) is a broad term and is to be given its ordinary and customary meaning to a person of ordinary skill in the art (i.e., it is not to be limited to a special or customized meaning) and includes, without limitation, any geometric primitive or other shape which may be used to indicate a selected volume within a virtual three-dimensional environment. Examples of certain of these shapes are provided in FIG. 10. “Receiving an indication” is a broad term and is to be given its ordinary and customary meaning to a person of ordinary skill in the art (i.e., it is not to be limited to a special or customized meaning) and includes, without limitation, the act of receiving an indication, such as a data signal, at an interface. For example, delivery of a data packet indicating activation of a particular feature to a port on a computer would comprise receiving an indication of that feature. A “VSO attachment point” is a broad term and is to be given its ordinary and customary meaning to a person of ordinary skill in the art (i.e., it is not to be limited to a special or customized meaning) and includes, without limitation, the three-dimensional position on a cursor relative to which the position, orientation, and scale of a VSO is determined. A “hand interface” or “hand device” is a broad term and is to be given its ordinary and customary meaning to a person of ordinary skill in the art (i.e., it is not to be limited to a special or customized meaning) and includes, without limitation, any system or device facilitating the determination of translation and rotation information of a user's hands. For example, hand-held controls, gyroscopic gloves, and gesture recognition camera systems, are all examples of hand interfaces. In the instance of a gesture recognition camera system, reference to a left or first hand interface and to a right or second hand interface will be understood to refer to hardware and/or software/firmware in the camera system which identifies translation and rotation of each of the user's left and right hands respectively. A “cursor” is a broad term and is to be given its ordinary and customary meaning to a person of ordinary skill in the art (i.e., it is not to be limited to a special or customized meaning) and includes, without limitation, any object in a virtual three-dimensional environment used to indicate to a user the corresponding position and/or orientation of their hand in the virtual environment. “Translation” is a broad term and is to be given its ordinary and customary meaning to a person of ordinary skill in the art (i.e., it is not to be limited to a special or customized meaning) and includes, without limitation, the movement from a first three-dimensional position to a second three-dimensional position along one or more axes of a Cartesian, or like, system of coordinates. “Translating” will be understood to therefore refer to the act of moving from a first position to a second position. “Rotation” is a broad term and is to be given its ordinary and customary meaning to a person of ordinary skill in the art (i.e., it is not to be limited to a special or customized meaning) and includes, without limitation, the amount of circular movement relative to a point, such as an origin, in a Cartesian, or like, system of coordinates. A “rotation” may also be taken relative to points other than the origin, when particularly specified as such. A “timepoint” is a broad term and is to be given its ordinary and customary meaning to a person of ordinary skill in the art (i.e., it is not to be limited to a special or customized meaning) and includes, without limitation, a point in time. One or more events may occur substantially simultaneously at a timepoint. For example, one skilled in the art will naturally understand that a computer system may execute instructions in sequence and that two functions, although processed in parallel, may in fact be executed in succession. Accordingly, although these instructions are executed within milliseconds of one another, they are still understood to occur at the same point in time, i.e., timepoint, for purposes of explanation herein. Thus, events occurring at the same, single timepoint will be perceived as occurring “simultaneously” to a human user. However, the converse is not true, as even though events occurring at two successive timepoints may be perceived as being “simultaneous” by the user, the timepoints remain separate and successive. A “frustum” or “viewing fustrum” is a broad term and is to be given its ordinary and customary meaning to a person of ordinary skill in the art (i.e., it is not to be limited to a special or customized meaning) and includes, without limitation, the portion of a 3-dimensional virtual environment visible to a user as determined by a rendering pipeline. One skilled in the art will recognize alternative geometric shapes from a frustum which may be used for this purpose. A “rendering pipeline” is a broad term and is to be given its ordinary and customary meaning to a person of ordinary skill in the art (i.e., it is not to be limited to a special or customized meaning) and includes, without limitation, the portion of a software system which indicates what objects in a three-dimensional environment are to be rendered and how they are to be rendered. To “fix” an object is a broad term and is to be given its ordinary and customary meaning to a person of ordinary skill in the art (i.e., it is not to be limited to a special or customized meaning) and includes, without limitation, the act of associating the translations and rotations of one object with the translations and rotations of another object in a three-dimensional environment. A “computer system” is a broad term and is to be given its ordinary and customary meaning to a person of ordinary skill in the art (i.e., it is not to be limited to a special or customized meaning) and includes, without limitation, any device comprising one or more processors and one or more memories capable of executing instructions embodied in a non-transitory computer-readable medium. The memories may themselves comprise a non-transitory computer-readable medium. An “orientation” is a broad term and is to be given its ordinary and customary meaning to a person of ordinary skill in the art (i.e., it is not to be limited to a special or customized meaning) and includes, without limitation, an amount of rotation. A “pose” is a broad term and is to be given its ordinary and customary meaning to a person of ordinary skill in the art (i.e., it is not to be limited to a special or customized meaning) and includes, without limitation, an amount of position and rotation. “Orientation” is a broad term and is to be given its ordinary and customary meaning to a person of ordinary skill in the art (i.e., it is not to be limited to a special or customized meaning) and includes, without limitation, a rotation relative to a default coordinate system. One will recognize that the terms “snap” and “nudge” as used herein refer to various operations particularly described below. Similarly, a “snap-scale” and a “nudge-scale” refer to particular operations described herein.

### System Overview

System Hardware Overview

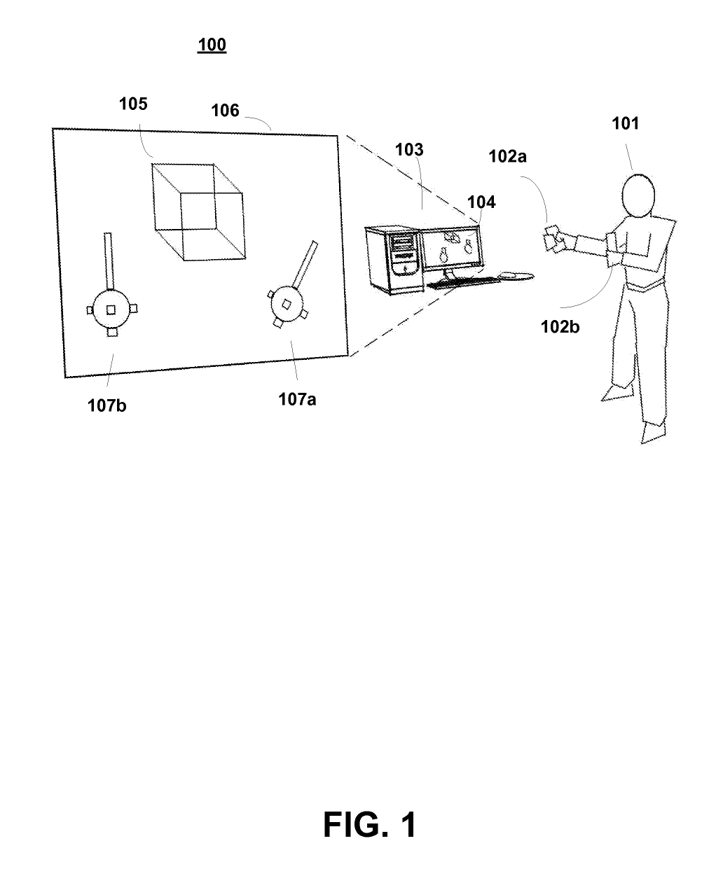

FIG. 1 illustrates a general system hardware arrangement which may be used to implement certain of the embodiments discussed herein. In this example, the user 101 may stand before a desktop computer 103 which includes a display monitor 104. Desktop computer 103 may include a computer system. The user 101 may hold a right hand interface 102a and a left hand interface 102b in each respective hand. One will readily recognize that the hand interfaces may be substituted with gloves, rings, finger-tip devices, hand-recognition cameras, etc. as are known in the art. Each of these devices facilitates system 103's receiving information regarding the position and orientation of user 101's hands. This information may be communicated wirelessly or wired to system 103. The system may also operate without the use of a hand interface, wherein an optical, range-finding, or other similar system is used to determine the location and orientation of the user's hands. The system 103 may convert this information, if it is not already received in such a form, into a translation and rotation component for each hand. One skilled in the art will readily recognize that translation and rotation information may be represented in a plurality of forms, such as by matrices of values, quaternions, dimension-dedicated arrays, etc.

In this example, display screen 104 depicts the 3-D environment in which the user operates. Although depicted here as a computer display screen, one will recognize that a television monitor, head-mounted display, a stereoscopic display, a projection system, and any similar display device may be used as well. For purposes of explanation, FIG. 1 includes an enlargement 106 of the display screen 104. In this example, the scene includes an object 105 referred to as a Volume Selection Object (VSO) described in greater detail below as well as a right cursor 107a and a left cursor 107b. Right cursor 107a tracks the movement of the hand interface 102a in the user 101's right hand, while left cursor 107b tracks the movement of the hand interface 102b in the user 101's left hand. Cursors 107a and 107b provide visual indicia for the user 101 to perform various operations described in greater detail herein and to coordinate the user's movement in physical space with movement of the cursors in virtual space. User 101 may observe display 104 and perform various operations while receiving visual feedback from the display.

Hand Interface

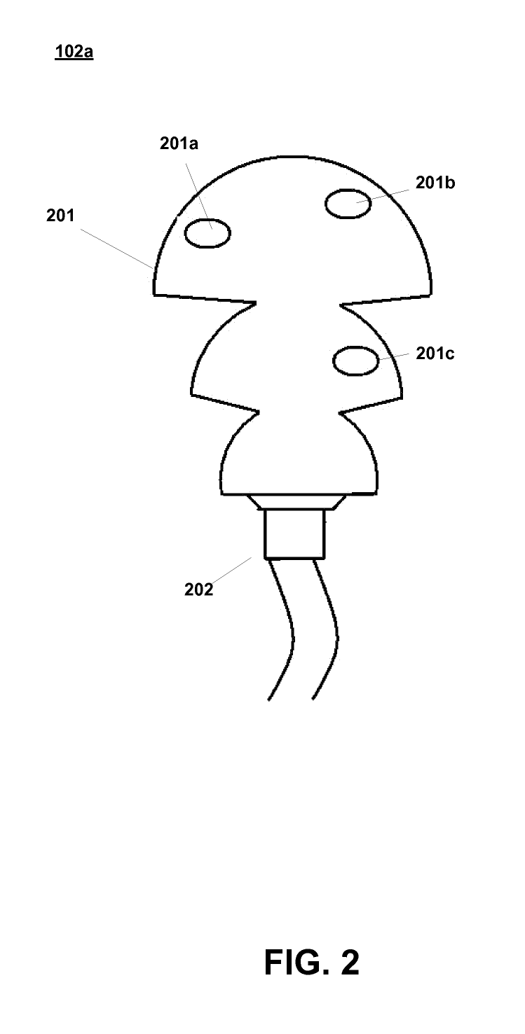

FIG. 2 illustrates an example hand interface 102a which may be used by the user 101. As discussed above, the hand interface may instead include a glove, a wand, hand as tracked by camera(s) or any similar device, and the device 102a of FIG. 2 is merely described for explanatory purposes. This particular device includes an ergonomic housing 201 around which the user may wrap his/her fingers. Within the housing, one or more positioning beacons, electromagnetic sensors, gyroscopic components, or other tracking components may be included to provide translation and rotation information of the hand interface 102a to system 103. In this example, information from these components is communicated via wired interface 202 to computer system 104 via a USB, parallel, or other port readily known in the art. One will readily recognize that a wireless interface may be substituted instead to facilitate communication of user 101's hand motion to system 103.

Hand interface 102a includes a plurality of buttons 201a-c. Button 201a is placed for access by the user 101's thumb. Button 201b is placed for access by the user 101's index finger and button 201c is placed for access by the user's middle finger. Additional buttons accessible by the user's ring and little fingers may also be provided, as well as alternative buttons for each finger. Operations may be assigned to each button, or to combinations of buttons, and may be reassigned dynamically depending upon the context in which they are depressed. In some embodiments, the left hand interface 102b will be a minor image, i.e. chiral, of the right hand interface 102a. As mentioned above, one will recognize that operations performed by clicking one of buttons 201a-c may instead be performed by performing a gesture, by issuing a vocal command, by typing on a keyboard, etc. For example, where a glove is substituted for the device 102a a user may perform a gesture with their fingers to perform an operation.

Cursor

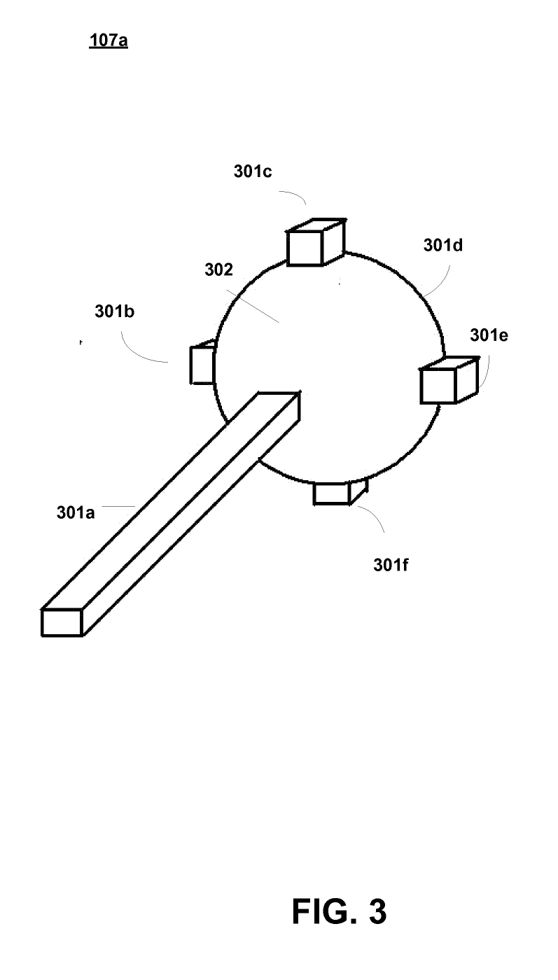

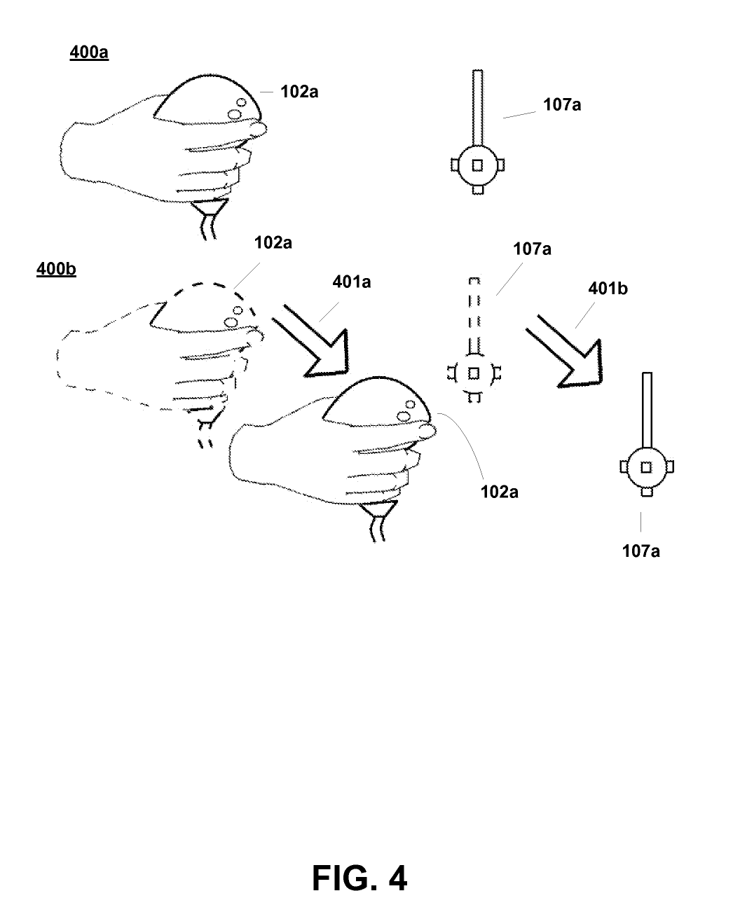

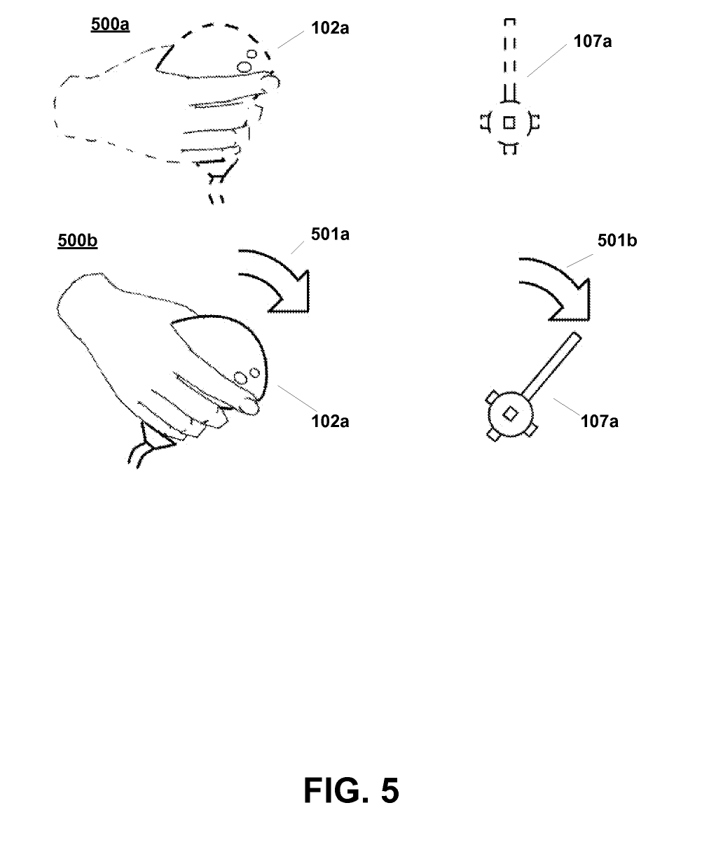

FIG. 3 is an enlargement and reorientation of the example right hand cursor 107a. The cursor may take any arbitrary visual form so long as it indicates to the user the location and rotation of the user's hand in the three-dimensional space. Asymmetric objects provide one class of suitable cursors. Cursor 107a indicates the six axes of freedom (a positive and negative for each dimension) by six separate rectangular boxes 301a-f located about a sphere 302. These rectangles provide orientation indicia, by which the user may determine the current translation and rotation of their hand as understood by the system. An asymmetry is introduced by elongating one of the axes rectangles 301a relative to the others. In some embodiments, the elongated rectangle 301a represents the axis pointing “away” from the user's hand, when in a default position. For example, if a user extended their hand as if to shake another person's hand, the rectangle 301a would be pointing distally away from the user's body along the axis of the user's fingers. This “chopstick” configuration allows the user to move the device in a manner similar to how they would operate a pair of chopsticks. For the purposes of explanation, however, in this document elongated rectangle 301a will instead be used to indicate the direction rotated 90 degrees upward from this position, i.e. in the direction of the user's thumb when extended during a handshake. This is more clearly illustrated by the relative position and orientation of the cursor 107a and the user's hand in FIGS. 4 and 5.

Cursor Translation Operations

The effect of user movement of devices 102a and 102b may be context dependent. In some embodiments, as indicated in FIG. 4, the default behavior is for translation of the handheld device 102a from a first position 400a to a second position 400b via displacement 401a will result in an equivalent displacement of the cursor 107a in the virtual three-dimensional space. In certain embodiments a scaling factor may be introduced between movement of the device 102a and movement of the cursor 107a to provide an ergonomic or more sensitive user movement.

Cursor Rotation Operations

Similarly, as indicated in FIG. 5, as part of the default behavior, rotation of the user's hand from a first position 500a to a second position 500b via degrees 501a may similarly result in rotation of the cursor 107a by corresponding degrees 501b. Rotation of the device 501a may be taken about the center of gravity of the device, although some systems may operate with a relative offset. Similarly, rotation of cursor 107a may generally be about the center of sphere 302, but could instead be taken about a center of gravity of the cursor or about some other offset.

Certain embodiments contemplate assigning specific roles to each hand. For example, the dominant hand alone may control translation and rotation while the non-dominant hand may control only scaling in the default behavior. In some implementations the user's hands' roles (dominant versus non-dominant) may be reversed. Thus, description herein with respect to one hand is merely for explanatory purposes and it will be understood that the roles of each hand may be reversed.

Universe Translation Operation

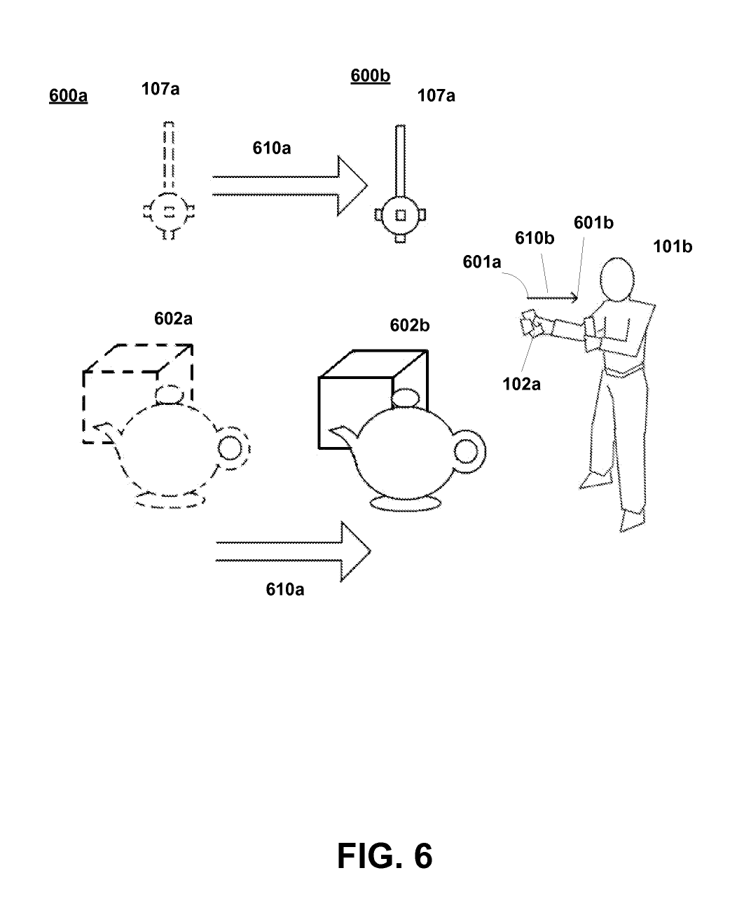

FIG. 6 illustrates the effect of user translation of the hand interface 102a when in viewpoint, or universal, mode. As used herein, viewpoint, or universal, mode refers to movement of the user's hand results in movement of the viewing frustum (or conversely movement of the three-dimensional universe relative to the user). In the example of FIG. 6 the user moves their right hand from a first location 601a to a second location 601b a distance 610b away. From the user's perspective, this may result in cursor 107a moving a corresponding distance 610a toward the user. Similarly, the three-dimensional universe, here consisting of a box and a teapot 602a, may also move a distance 610a closer to the user from the user's perspective as in 602b. Note that in the context described above, where hand motion correlates only with cursor motion, this gesture would have brought the cursor 107a closer to the user, but not the universe of objects. Naturally, one will recognize that the depiction of user 101b in the virtual environment in this and subsequent figures is merely for explanatory purposes to provide a conceptual explanation of what the user perceives. The user may remain fixed in physical space, even as they are shown moving themselves and their universe in virtual space.

Universe Rotation Operation

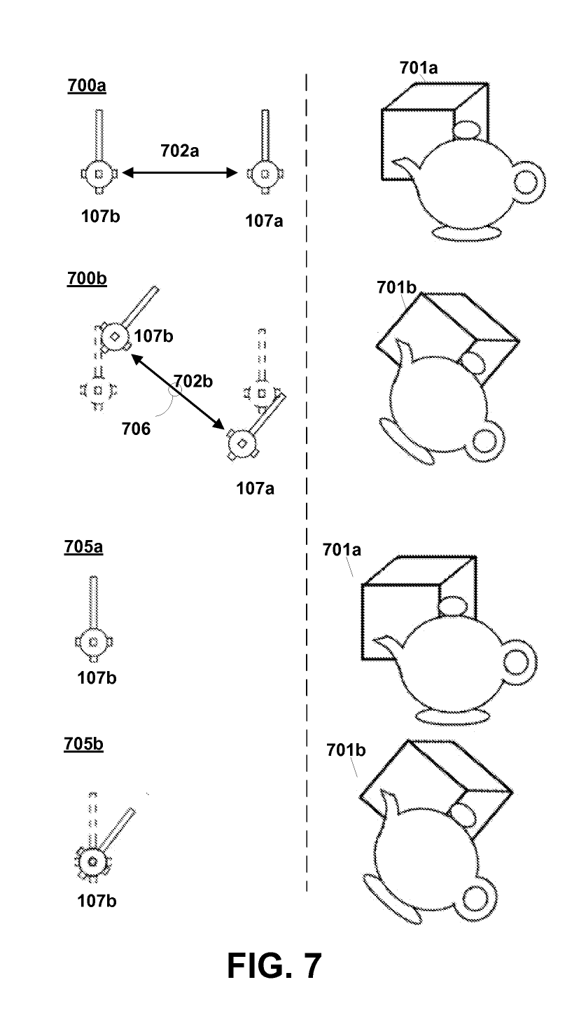

FIG. 7 depicts various methods for performing a universal rotation, or conversely a viewpoint rotation, operation. Elements to the left of the dashed line indicate how the cursors 107a and 107b appear to the user, while items to the right of the dashed line indicate how items in the universe appear to the user. In the transition from state 700a to 700b the user uses both hands, represented by cursors 107a and 107b to perform a rotation. This “steering wheel” rotation somewhat mimics the user's rotation of a steering wheel when driving a car. However, unlike a steering wheel, the point of rotation may not be the center of an arbitrary circle with the handles along the periphery. Rather, the system may, for example, determine a midpoint between the two cursors 107a and 107b which are located a distance 702a apart. This midpoint may then used as a basis for determining rotation of the viewing frustum or universe as depicted by transition of objects from orientation 701a to orientation 701b as perceived by a user looking at the screen. In this example, a clockwise rotation in the three-dimensional space corresponds to a clockwise rotation of the hand-held devices. Some users may find this intuitive as their hand motion tracks the movement of the universe. One could readily imagine a system which performs the converse, however, by rotating the universe in a counter-clockwise direction for a clockwise hand rotation, and vice versa. This alternative behavior may be more intuitive for users who feel they are “grabbing the viewing frustum” and rotating it in the same manner as they would a hand-held camera. Graphical indicia may be used to facilitate the user's performance of this operation. Although the universe is shown rotating about its center in the configuration 700b, one will recognize that the universe may instead be rotated about the centerpoint 706.

The user's hands may instead work independently to perform certain operations, such as universal rotation. For example, in an alternative behavior depicted in the transition from states 705a to 705b, rotation of the user's left or right hand individually may result in the same rotation of the universe from orientation 701a to orientation 701b as was achieved by the two-handed method. In some embodiments, the one-handed rotation may be about the center point of the cursor.

In some embodiments, the VSO may be used during the processes depicted in FIG. 7 to indicate the point about which a universal rotation is to be performed (for example, the center of gravity of the VSO's selection volume). In some embodiments this process may be facilitated in conjunction with a snap operation, described below, to bring the VSO to a position in the user's hand convenient for performing the rotation. This may provide the user with the sensation that they are rotating the universe by holding it in one hand. The VSO may also be used to rotate portions of the universe, such as objects, as described in greater detail below.

Universe Scaling Operation

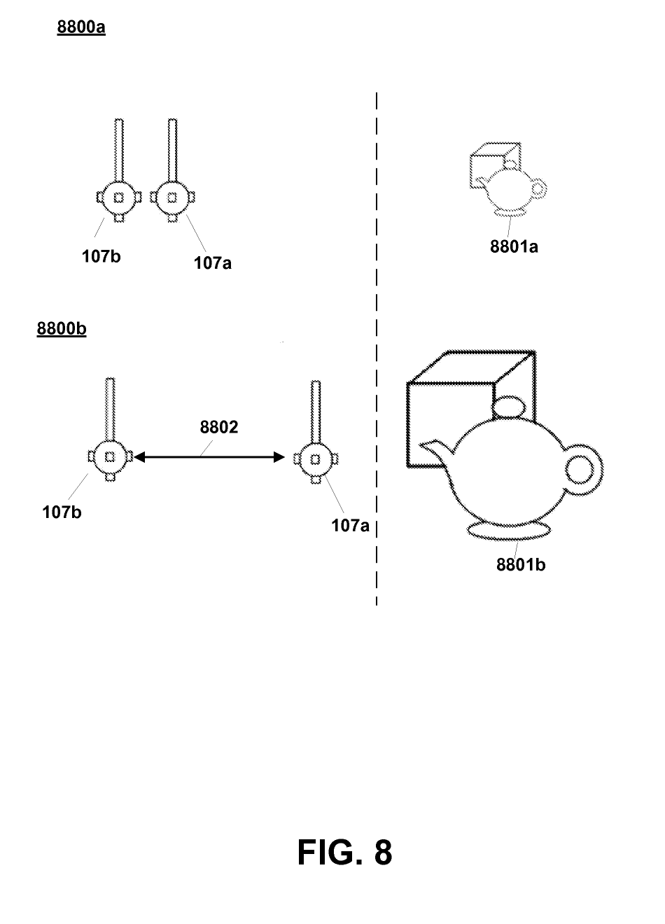

FIG. 8 depicts one possible method for performing a universal scaling operation. Elements to the left of the dashed line indicate how the cursors 107a and 107b appear to the user, while items to the right of the dashed line indicate how items in the universe appear to the user. A user desiring to enlarge the universe (or conversely, to shrink the viewing frustum) may place their hands close together as depicted in the locations of cursors 107a and 107b in configured 8800a. They may then indicate that a universal scale operation is to be performed, such as by clicking one of buttons 201a-c, issuing a voice command, etc. As the distance 8802 between their hands increases, the scaling factor used to render the viewing frustum will accordingly be scaled, so that objects in an initial configuration 8801a are scaled to a larger configuration 8801b. Conversely, the user may scale in the opposite manner, by separating their hands a distance 8802 prior to indicating that a scaling operation is to be performed. They may then indicate that a universal scaling operation is to be performed and bring their hands closer together. The system may establish upper and lower limits upon the scaling based on the anticipated or known length of the user's arms. One will recognize variations in the scaling operation, such as where the translation of the viewing frustum is adjusted dynamically during the scaling to give the appearance to the user of maintaining a fixed distance from a collection of objects in the virtual environment.

Object Rotation and Translation

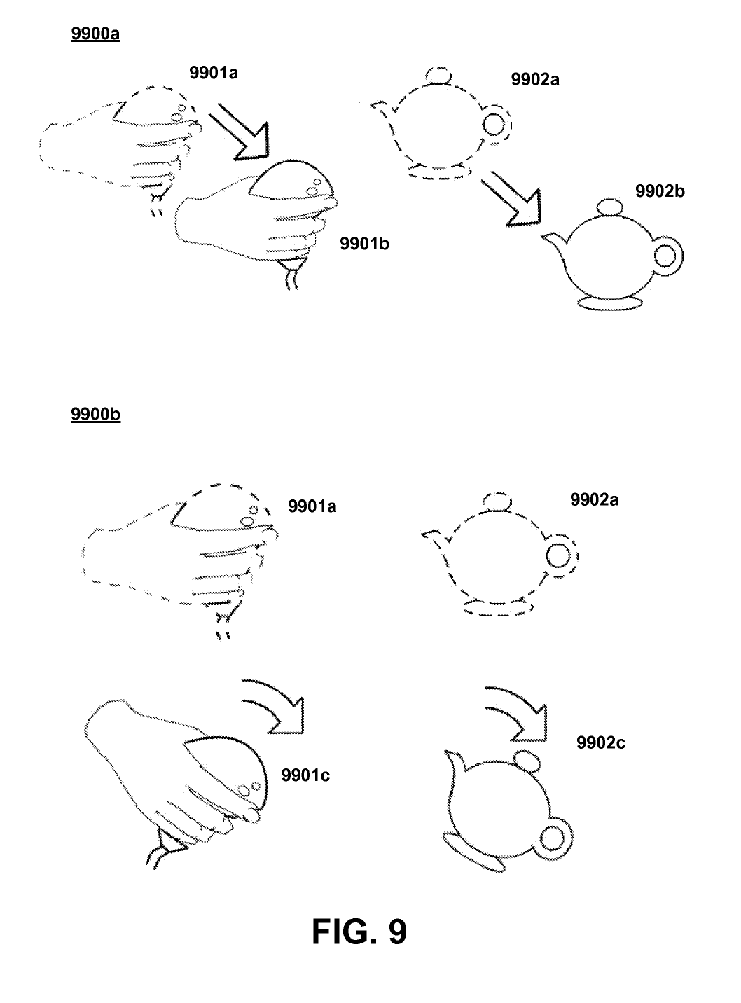

FIG. 9 depicts various operations in which the user moves an object in the three-dimensional environment using their hand. By placing a cursor on, within, intersecting, or near an object in the virtual environment, and indicating that the object is to be “attached” or “fixed” to the cursor, the user may then manipulate the object as shown in FIG. 9. In the same manner as when the cursor 107a tracks the movement of user's hand interface 102a, the user may depress a button so that an object in the 3D environment is translated and rotated in correspondence with the position and orientation of hand interface 102a. In some embodiments, this rotation may be about the object's center of mass, but may also be about the center of mass of the subportion of the object selected by the user or about an offset from the object. In some embodiments, when the user positions the cursor in or on a virtual object and presses a specified button, the object is then locked to that hand. Once “grabbed” in this manner, as the user translates and rotates his/her hand, the object translates and rotates in response. Unlike viewpoint movement, discussed above, where all objects in the scene move together, the grabbed object moves relative to the other objects in the scene, as if it was being held in the real world. A user may manipulate the VSO in the same manner as they manipulate any other object.

The user may grab the object with “both hands” by selecting the object with each cursor. For example, if the user grabs a rod at each end, one end with each hand, the rod's ends will continue to track the two hands as the hands move about. If the object is scalable, the original grab points will exactly track to the hands, i.e., bringing the user's hands closer together or farther apart will result in a corresponding scaling of the object about the midpoint between the two hands or about an object's center of mass. However, if the object is not scalable, the object will continue to be oriented in a direction consistent with the rotation defined between the user's two hands, even if the hands are brought closer or farther apart.

### Visual Selection Object (VSO)

Selecting, modifying, and navigating a three-dimensional environment using only the cursors 107a and 107b may be unreasonably difficult for the user. This may be especially true where the user is trying to inspect or modify complex objects having considerable variation in size, structure, and composition. Accordingly, in addition to navigation and selection using cursors 107a and 107b certain embodiments also contemplate the use of a volume selection object (VSO). The VSO serves as a useful tool for the user to position, orient, and scale themselves and to perform various operations within the three-dimensional environment.

Example Volumetric Selection Objects (VSO)

A VSO may be rendered as a wireframe, semi-transparent outline, or any other suitable representation indicating the volume currently under selection. This volume is referred to herein as the selection volume of the VSO. As the VSO need only provide a clear depiction of the location and dimensions of a selected volume, one will recognize that a plurality of geometric primitives may be used to represent the VSO. FIG. 10 illustrates a plurality of possible VSO shapes. For the purposes of discussion a rectangle or cube 801 is most often represented in the figures provided herein. However, a sphere 804 or other geometric primitive could also be used. As the user deforms a spherical VSO the sphere may assume an ellipsoid 805 or tubular 803 shapes in a manner analogous to cube 801's forming various rectangular box shapes. More exotic combinations of geometric primitives such as the carton 802 may be readily envisioned. Generally, the volume rendered will correspond to the VSO's selection volume, however this may not always be the case. In some embodiments the user may specify the geometry of the VSO, possibly by selecting the geometry from a plurality of geometries.

Although the VSO may be moved like an object in the environment, as was discussed in relation to FIG. 9, certain of the present embodiments contemplate the user selecting, positioning and orienting the VSO using more advanced techniques, referred to as snap and nudge, described further below.

### Snap Operation

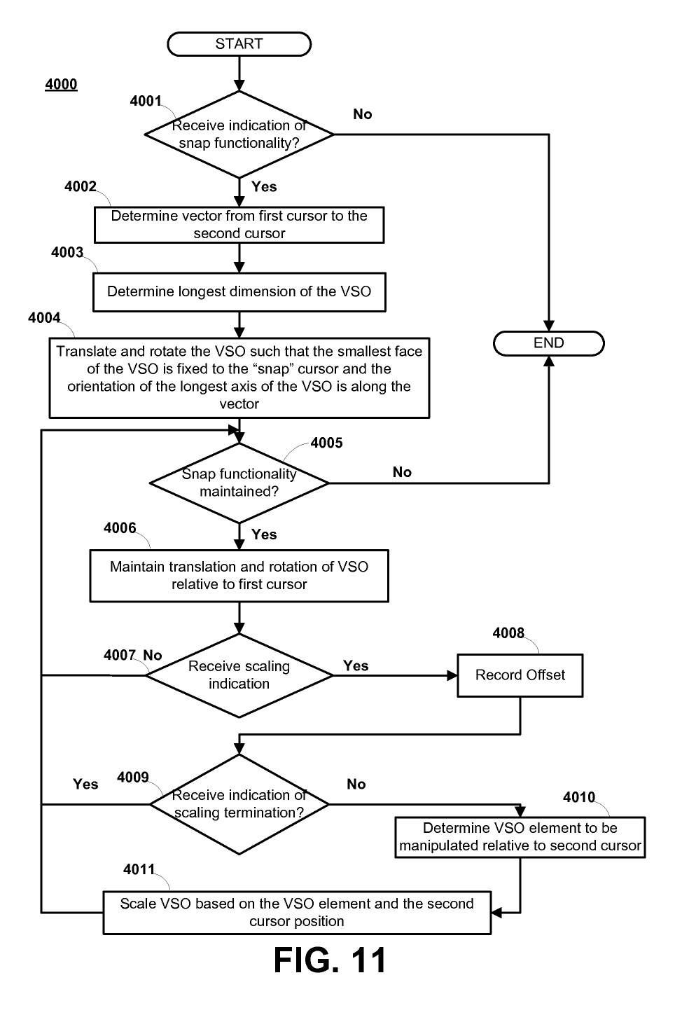

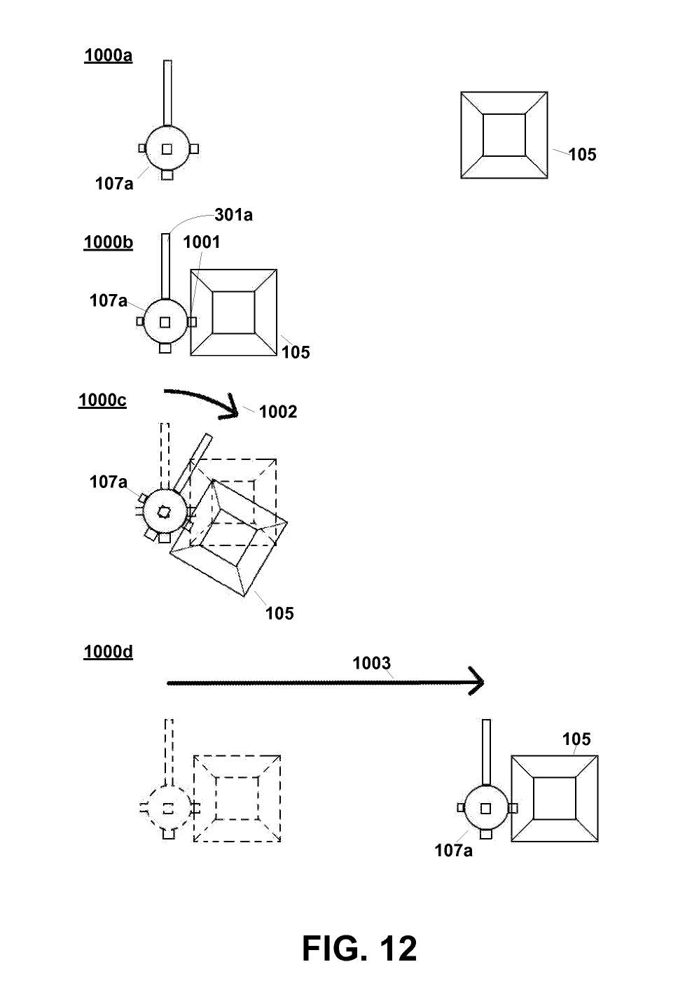

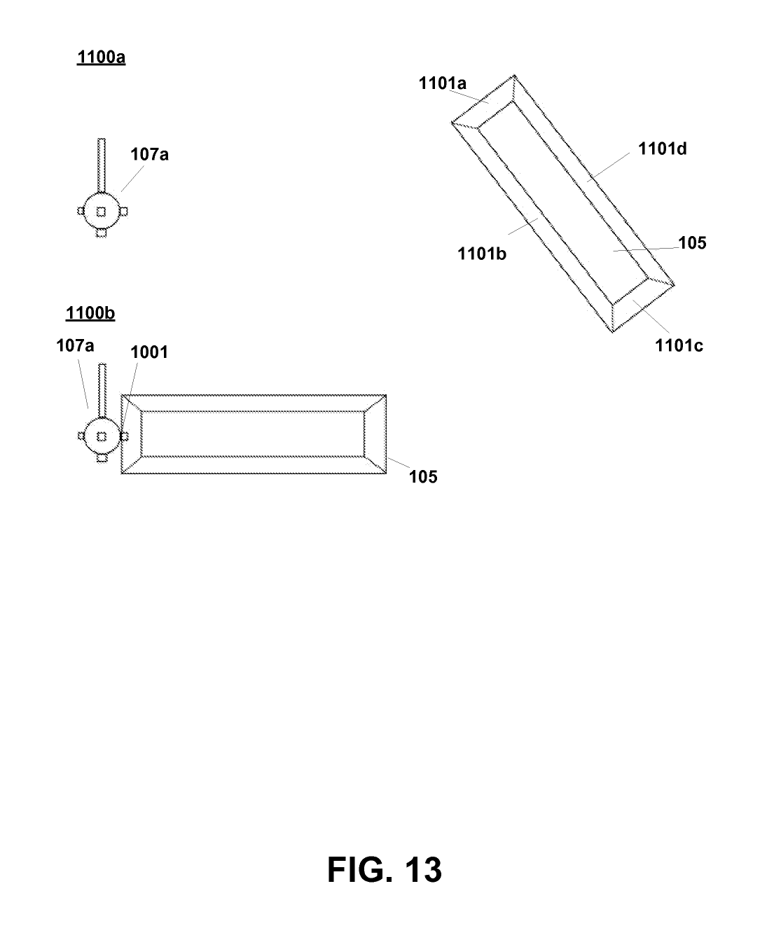

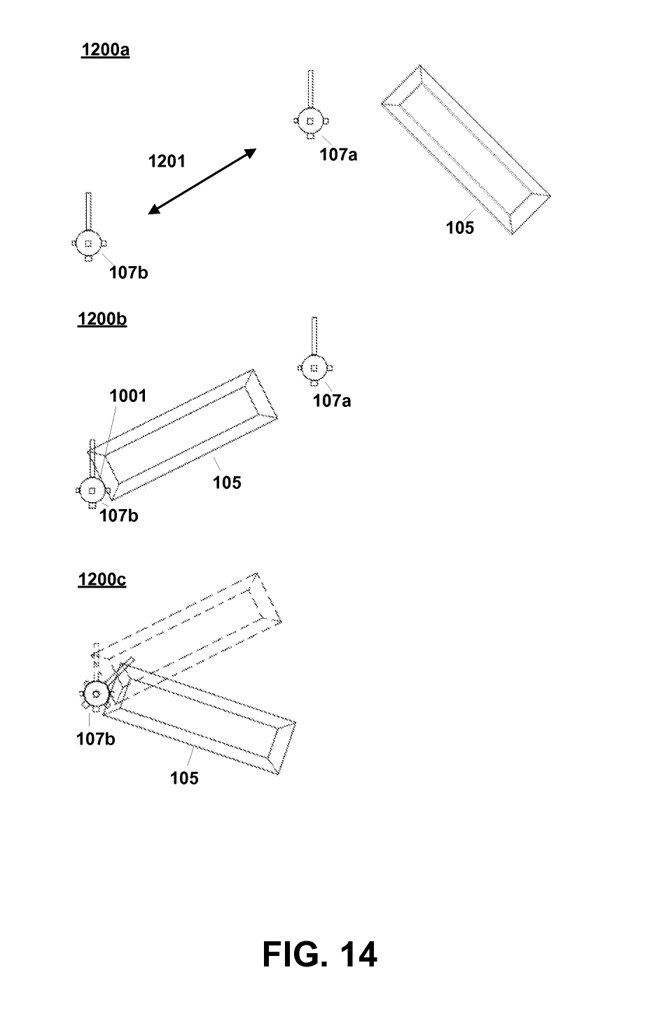

FIG. 11 is a flow diagram depicting certain steps of a snap operation as may be implemented in certain embodiments. Reference will be made to FIGS. 12-15 to facilitate description of various features, although FIG. 12 and FIG. 13 refer to a one-handed snap, while FIG. 14 makes use of two hands. While a specific sequence of steps may be described herein with respect to FIG. 11, it will be recognized that same or similar functionality can also be achieved if the sequences of these acts is varied or carried out in a different order. The sequence of FIG. 11 is but one embodiment, and it will be recognized that the acts may be achieved in a different sequence, by removing certain acts, or adding certain acts.

Initially, as depicted in configuration 1000a of FIG. 12, a cursor 107a and the VSO 105, depicted as a cube in FIG. 12, are separated by a certain distance. One will readily recognize that this figure depicts and ideal case, and that in a real virtual world, objects may be located between the cursor and VSO and the VSO may not be visible to the user.

At step 4001 the user may provide an indication of snap functionality to the system at a first timepoint. For example, the user may depress or hold down a button 201a-c. As discussed above, the user may instead issue a voice command or the like, or provide some other indication that snap functionality is desired. If an indication has not yet been provided, the process may end until snap functionality is reconsidered.

The system may then, at step 4002, determine a vector from the first cursor to the second cursor. For example, a vector 1201 as illustrated in FIG. 14 may be determined. As part of this process the system may also determine a location, within, or outside a cursor to serve as an attachment point. In FIG. 12 this point is the center, rightmost-side 1001 of the cursor. This location may be hard-coded or predetermined prior to the user's request and may accordingly be simply referred to by the system when “determining”. For example, in FIG. 12 the system always seeks to attach the VSO 105 to the right side of cursor 107a, situated at the attachment point 1001, and parallel with rectangle 301a as indicated. This position may correspond to the “palm” of the user's hand, and accordingly the operation gives the impression of placing the VSO in the user's palm.

At step 4003 the system may similarly determine a longest dimension of the VSO or a similar criterion for orienting the VSO. As shown in FIG. 13 when transitioning from the configuration of 1100a to 1100b, the system may reorient the VSO relative to the user's hand. This step may be combined with step 4004 where the system translates and rotates the VSO such that the smallest face of the VSO is fixed to the “snap” cursor (i.e., the left cursor 107b in FIG. 14). The VSO may be oriented along its longest axis in the direction of the vector 1201 as indicated in FIG. 14.

At step 4005 the system may then determine if the snap functionality is to be maintained. For example, the user may be holding down a button to indicate that snap functionality is to continue. If this is the case, in step 4006 the system will maintain the translation and rotation of the VSO relative to the cursor as shown in configuration 1200c of FIG. 14.

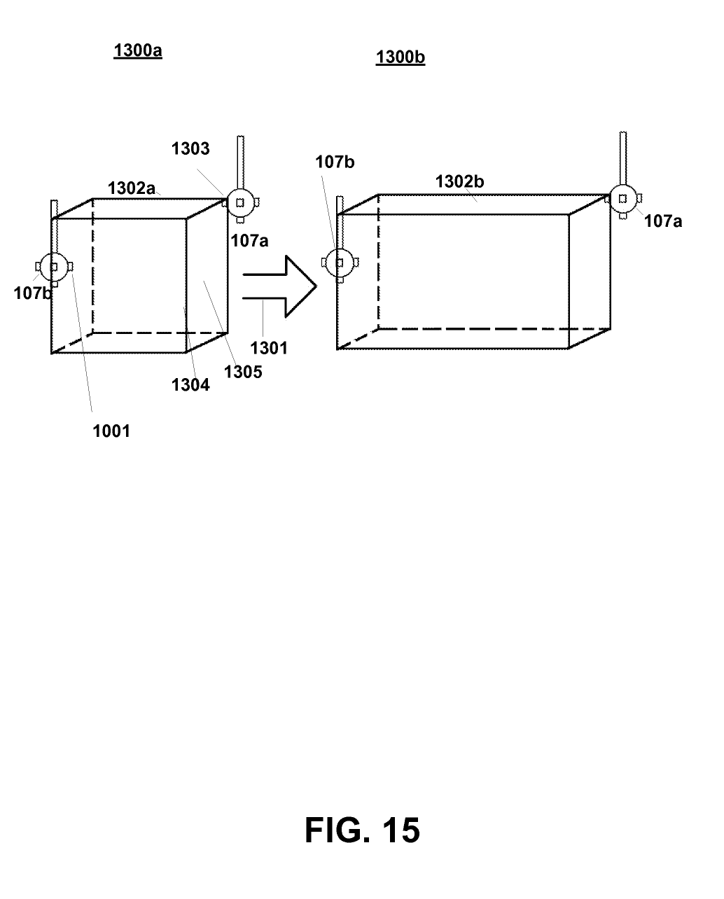

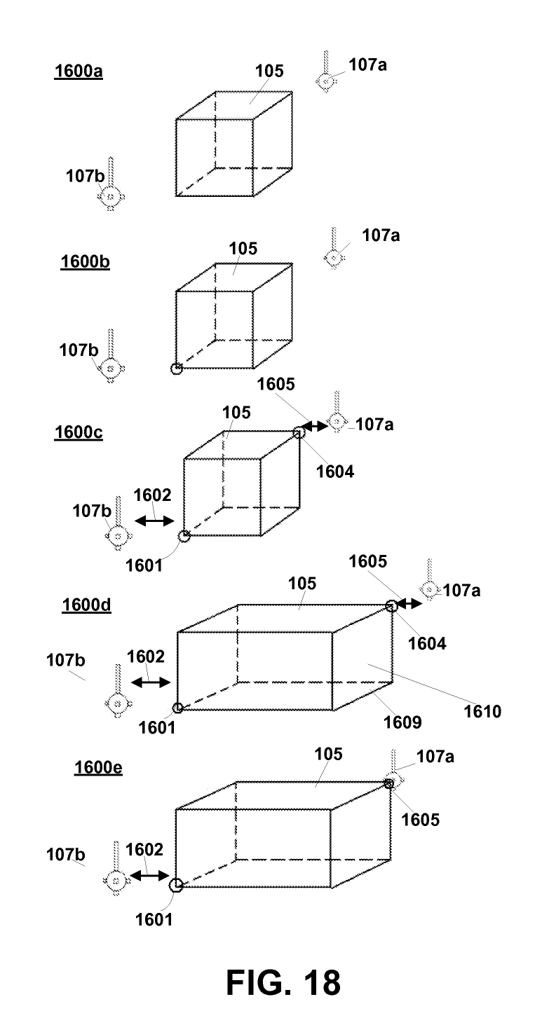

Subsequently, possibly at a second timepoint at step 4007, the system may determine if scaling operation is to be performed following the snap as will be discussed in greater detail with respect to FIG. 15. If a scaling snap is to be performed, the system may record one or more offsets 1602, 1605 as illustrated in FIG. 18. At decision block 4009 the system may then determine whether scaling is to be terminated (such as by a user releasing a button). If scaling is not terminated, the system determines a VSO element, such as a corner 1303, edge 1304, or face 1305 on which to perform the scaling operation about the oriented attachment point 107a, i.e. the snap cursor as portrayed in 4010. The system may then scale the VSO at step 4011 prior to again assessing if further snap functionality is to be performed. This scaling operation will be discussed in greater detail with reference to FIG. 15.

Snap Position and Orientation

As discussed above, the system may determine the point relative to the first cursor to serve as an attachment point at step 4002 as well as to determine the attachment point and orientation of the VSO following the snap at steps 4003 and 4004. FIG. 13 depicts a first configuration 1100a wherein the VSO is elongated and oriented askew from the desired snap position relative to cursor 107a. A plurality of criterion, or heuristics, may be used for the system to determine which face of faces 1101a-d to use as the attachment point relative to the cursor 107a. In some embodiments, any element of the VSO, such as a corner or edge may be used. It is preferable to retain the dimensions of the VSO 105 following a snap to facilitate the user's selection of an object. For example, the user may have previously adjusted the dimensions of the VSO to be commensurate with that of an object to be selected. If these dimensions were changed during the snap operation, this could be rather frustrating for the user.

In this example, the system may determine the longest axis of the VSO 105, and because the VSO is symmetric, select either the center of face 1101a or 1101c as the attachment point 1001. This attachment point may be predefined by the software or the user may specify a preference to use sides 1101b or 1101d along the opposite axis, by depressing another button, or providing other preference indicia.

Snap Direction-Selective Orientation

In contrast to the single-handed snap of FIG. 12, to even further facilitate a user's ability to orient the VSO, a direction-selective snap may also be performed using both hand interfaces 102a-b as depicted in FIG. 14. In this operation, the system first determines a direction vector 1201 between the cursors 107a and 107b as in configuration 1200a, such as at step 4002. When snap functionality is then requested, the system may then move the VSO to a location in, on, or near cursor 107b such that the axis associated with the VSO's longest dimension is fixed in the same orientation 1201 as existed between the cursors. Subsequent translation and rotations of the cursor, as shown in configuration 1200c will then maintain the cursor-VSO relationship as discussed with respect to FIG. 12. However, this relationship will now additionally maintain the relative orientation, indicated by vector 1201, that existed between the cursors at the time of activation. Additionally, the specification of the VSO position and orientation in this manner may allow for more comfortable manipulation relative to the ‘at rest’ VSO position and orientation.

Snap Scale

As suggested above, the user may wish to adjust the dimensions of the VSO for various reasons. FIG. 15 depicts this operation as implemented in one embodiment. After initiating a snap operation, the user may then initiate a scaling operation, perhaps by another button press. This operation 1301 is performed on the dimensions of the VSO from a first configuration 1302a to a second configuration 1302b as cursors 107b and 107a are moved relative to one another. Here, the VSO 105 remains fixed to the attachment point 1001 of the cursor 107b during the scaling operation. The system may also determine where on the VSO to attach the attachment point 1001 of the cursor 107b. In this embodiment, the center of the left-most face of the VSO is used. The side corner 1303 of the VSO opposite the face closest to the viewpoint is attached to the cursor 107a. In this example, the user has moved cursor 107a to the right from cursor 107b and accordingly elongated the VSO 105.

Although certain embodiments contemplate that the center of the smallest VSO face be affixed to the origin of the user's hand as part of the snap operation, one will readily recognize other possibilities. The position and orientation described above, however, where one hand is on a center face and the other on a corner, affords faster, more general, precise, and predictable VSO positioning. Additionally, the specification of the VSO position and orientation in this manner allows for more comfortable manipulation relative to the ‘at rest’ VSO position and orientation.

Generally speaking, certain embodiments contemplate the performance of tasks with the hands asymmetrically—that is where each hand performs a separate function. This does not necessarily mean that each hand performs its task simultaneously although this may occur in certain embodiments. In one embodiment, the user's non-dominant hand may perform translation and rotation, whereas the dominant hand performs scaling. The VSO may translate and rotate along with the non-dominant hand. The VSO may also rotate and scale about the cursor position, maintaining the VSO-hand relationship at the time of snap as described above and in FIG. 14. The dominant hand may directly control the size of the box (uniform or non-uniform scale) separately in each of the three dimensions by moving the hand closer to, or further away, from the non-dominant hand.

As discussed above, the system may determine that a VSO element, such as a corner 1303, edge 1304, or face 1305 may be used for scaling relative to non-snap cursor 107a. Although scaling is performed in only one dimension in FIG. 15, selection of a vertex 1303 may permit adjustment in all three directions. Similarly, selection of an edge 1304 may facilitate scaling along the two dimensions of each plane bordering the edge. Finally, selection of a face 1305 may facilitate scaling in a single dimension orthogonal to the face, as shown in FIG. 15.

### Nudge Operation

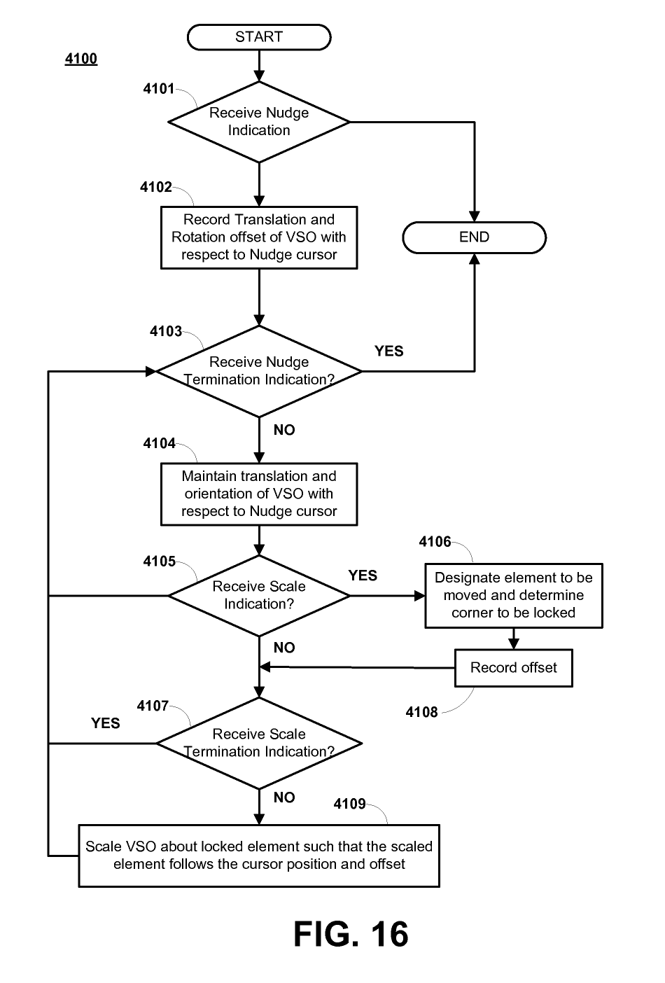

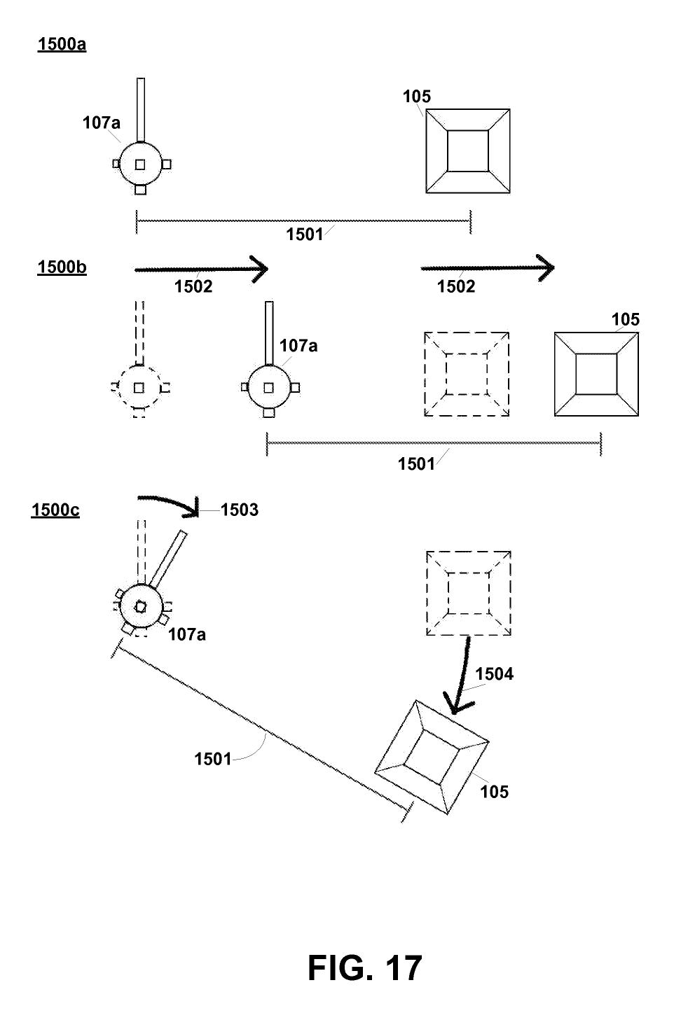

Certain of the present embodiments contemplate another operation for repositioning and reorienting the VSO referred to herein as nudge. FIG. 16 is a flow chart depicting various steps of the nudge operation as implemented in certain embodiments. Reference will be made to FIG. 17 to facilitate description of various of these features. While a specific sequence of steps may be described herein with respect to FIG. 16, it will be recognized that same or similar functionality can also be achieved if the sequences of these acts is varied or carried out in a different order. The sequence of FIG. 16 is but one embodiment, and it will be recognized that the acts may be achieved in a different sequence, by removing certain acts, or adding certain acts.

At step 4101 the system receives an indication of nudge functionality activation at a first timepoint. As discussed above with respect to the snap operation, this may take the form of a user pressing a button on the hand interface 102a. As shown in FIG. 17 the cursor 107a may be located a distance and rotation 1501 from VSO 105. Such a position and orientation may be reflected by a vector representation in the system. In some embodiments this distance may be considerable, as when the user wishes to manipulate a VSO that is extremely far beyond their reach.

At step 4102, the system determines the offset 1501 between the cursor 107a and the VSO 105. In FIG. 18 this “nudge” cursor is the cursor 107b and the distance of the offset the distance 1602. The system may represent this relationship in a variety of forms, such as by a vector. Unlike the snap operation, the orientation and translation of the VSO may not be adjusted at this time. Instead, the system waits for movement of the cursor 107a by the user.

At 4103 the system may then determine if the nudge has terminated, in which case the process stops. If the nudge is to continue, the system may maintain the translation and rotation of the VSO at step 4104 while the nudge cursor is manipulated, as indicated in configurations 1500b and 1500c. As shown in FIG. 17, movement of the VSO 105 tracks the movement of the cursor 107a. At step 4105 the system may determine if a nudge scale operation is to be performed. If so, at step 4106 the system may designate an element of the VSO from which to determine offset 1605 to the other non-nudge cursor. In FIG. 18, the non-nudge cursor is cursor 107a and the element selected is the corner 1604. One will recognize that the system may instead select the elements edge 1609 or face 1610. Scaling in particular dimensions based on the selected element may be the same as in the snap scale operation discussed above, where a vertex facilitates three dimensions of freedom, an edge two dimensions, and a face one. The system may then record this offset 1605 at step 4108. As shown in the configuration 1600e this offset may be zero in some embodiments, and the VSO element adjusted to be in contact with the cursor 107a.

If the system then terminates scaling 4107 the system will return to state 4103 and assess whether nudge functionality is to continue. Otherwise, at step 4109 the system may perform scaling operations using the two cursors as discussed in greater detail below with respect to FIG. 18.

Nudge Scale

As scaling is possible following the snap operation, as described above, so to is scaling possible following a nudge operation. As shown in FIG. 18, a user may locate cursors 107a and 107b relative to a VSO 105 as shown in configuration 1600a. The user may then request nudge functionality as well as a scaling operation. While one handed nudge can translate and rotate the VSO, the second hand may be used to change the size/dimensions of the VSO. As illustrated in configuration 1600c the system may determine the orientation and translation 1602 between cursor 107b and the corner 1601 of the VSO 105 closest to the cursor 107b. The system may also determine a selected second corner 1604 to associate with cursor 107a. One will recognize that the sequence of assignment of 1601 and 1604 may be reversed. Subsequent relative movement between cursors 107a and 107b as indicated in configuration 1600d will result in an adjustment to the dimensions of VSO 105.

The nudge and nudge scale operations thereby provide a method for controlling the position, rotation, and scale of the VSO. In contrast to the snap operation, when the Nudge is initiated the VSO does not “come to” the user's hand. Instead, the VSO remains in place (position, rotation, and scale) and tracks movement of the user's hand. While the nudge behavior is active, changes in the user's hand position and rotation are continuously conveyed to the VSO.

### Posture and Approach Operation

Certain of the above operations when combined, or operated nearly successively, provide novel and ergonomic methods for selecting objects in the three-dimensional environment and for navigating to a position, orientation, and scale facilitating analysis. The union of these operations is referred to herein as posture and approach and broadly encompasses the user's ability to use the two-handed interface to navigate both the VSO and themselves to favorable positions in the virtual space. Such operations commonly occur when inspecting a single object from among a plurality of complicated objects. For example, when using the system to inspect volumetric data of a handbag and its contents, it may require skill to select a bottle of chapstick independently from all other objects and features in the dataset. While this may be possible without certain of the above operations, it is the union of these operations that allows the user to perform this selection much more quickly and intuitively than would be possible otherwise.

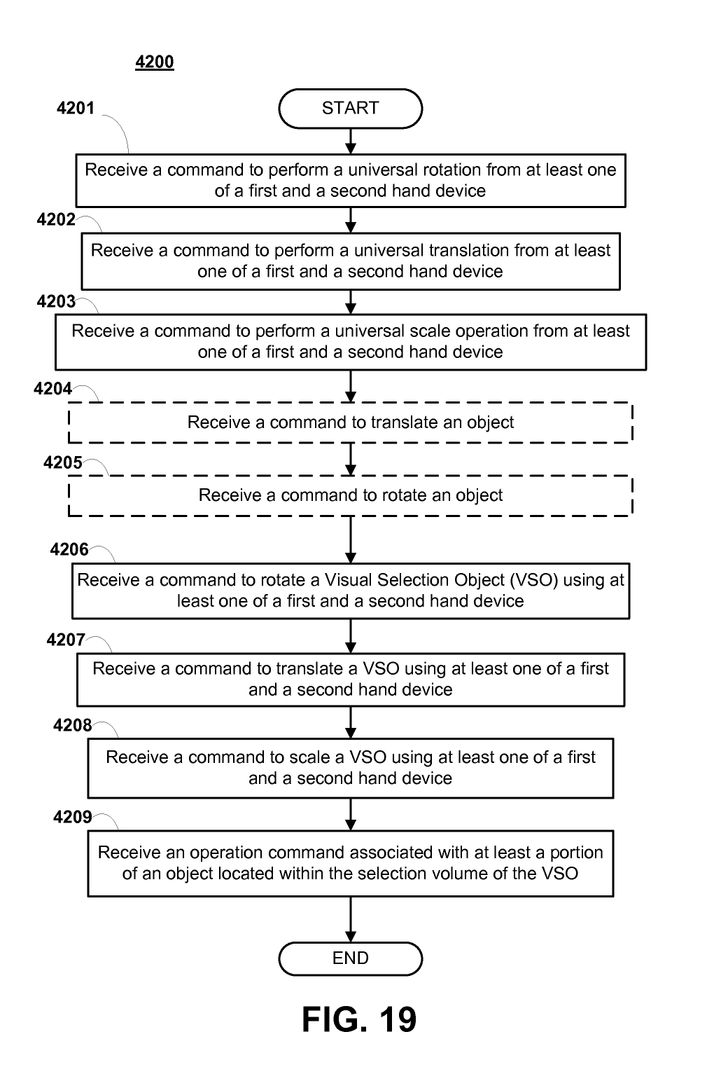

FIG. 19 is a flowchart broadly outlining various steps in these operations. While a specific sequence of steps may be described herein with respect to FIG. 19, it will be recognized that same or similar functionality can also be achieved if the sequences of these acts is varied or carried out in a different order. The sequence of FIG. 19 is but one embodiment, and it will be recognized that the acts may be achieved in a different sequence, by removing certain acts, or adding certain acts.

At steps 4201-4203 the user performs various rotation, translation, and scaling operations to the universe to arrange an object as desired. Then, at steps 4204 and 4205 the user may specify that the object itself be directly translated and rotated, if possible. In certain volumetric dataset, manipulation of individual objects may not be possible as the data is derived from a fixed, real-world measurement. For example, an X-ray or CT scan inspection of the above handbag may not allow the user to manipulate a representation of the chapstick therein. Accordingly, the user will need to rely on other operations, such as translation and rotation of the universe to achieve an appropriate vantage and reach point.

The user may then indicate that the VSO be translated, rotated, and scaled at steps 4206-4208 to accommodate the dimensions of the object under investigation. Finally, once the VSO is placed around the object as desired, the system may receive an operation command at step 4209. This command may mark the object, or otherwise identify it for further processing. Alternatively, the system may then adjust the rendering pipeline so that objects within the VSO are rendered differently. As discussed in greater detail below the object may be selectively rendered following this operation. The above steps may naturally be taken out of the order presented here and may likewise overlap one another temporally.

Posture and approach techniques may comprise growing or shrinking the virtual world, translating and rotating the world for easy and comfortable reach to the location(s) needed to complete an operation, and performing nudges or snaps to the VSO, via a THI system interface. These operations better accommodate the physical limitations of the user, as the user can only move their hands so far or so close together at a given instant. Generally, surrounding an object or region is largely about reach and posture and approach techniques accommodate these limitations.

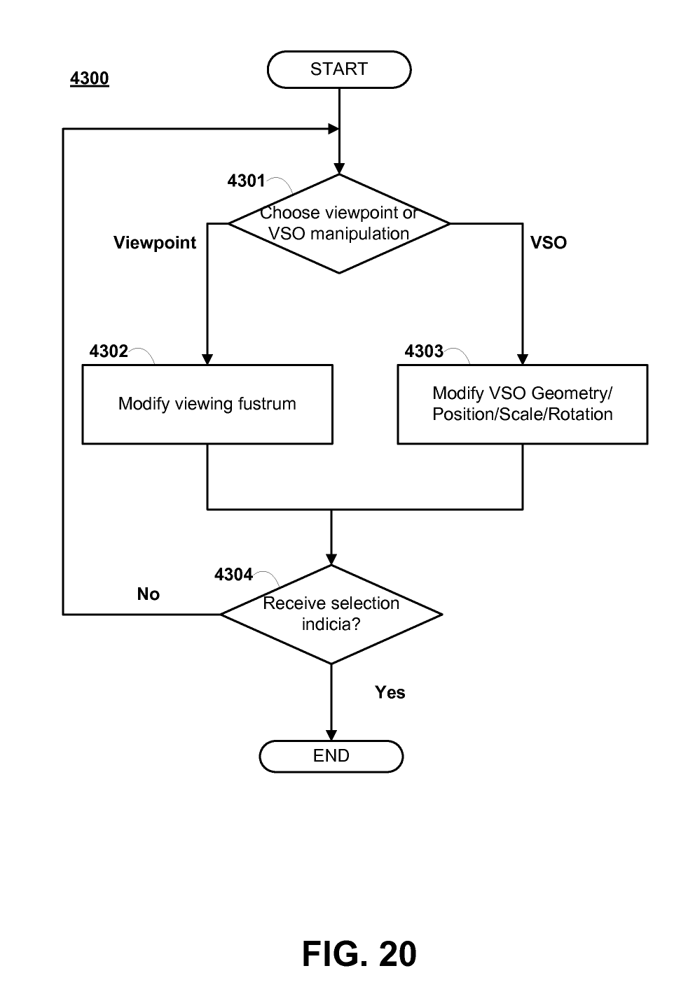

FIG. 20 is another flowchart generally illustrating the relation between viewpoint and VSO manipulation as part of a posture and approach technique. While a specific sequence of steps may be described herein with respect to FIG. 20, it will be recognized that same or similar functionality can also be achieved if the sequences of these acts is varied or carried out in a different order. The sequence of FIG. 20 is but one embodiment, and it will be recognized that the acts may be achieved in a different sequence, by removing certain acts, or adding certain acts.

At step 4301 the system may determine whether a VSO or a viewpoint manipulation is to be performed. Such a determination may be based on indicia received from the user, such as a button click as part of the various operations discussed above. If viewpoint manipulation is selected, then the viewpoint of the viewing frustum may be modified at step 4302. Alternatively, at step 4303, the properties of the VSO, such as its rotation, translation, scale, etc. may be modified. At step 4304 the system may determine whether the VSO has been properly placed, such as when a selection indication is received. One will recognize that the user may iterate between states 4302 and state 4303 multiple times as part of the posture and approach process.

### Posture and Approach

### Example 1

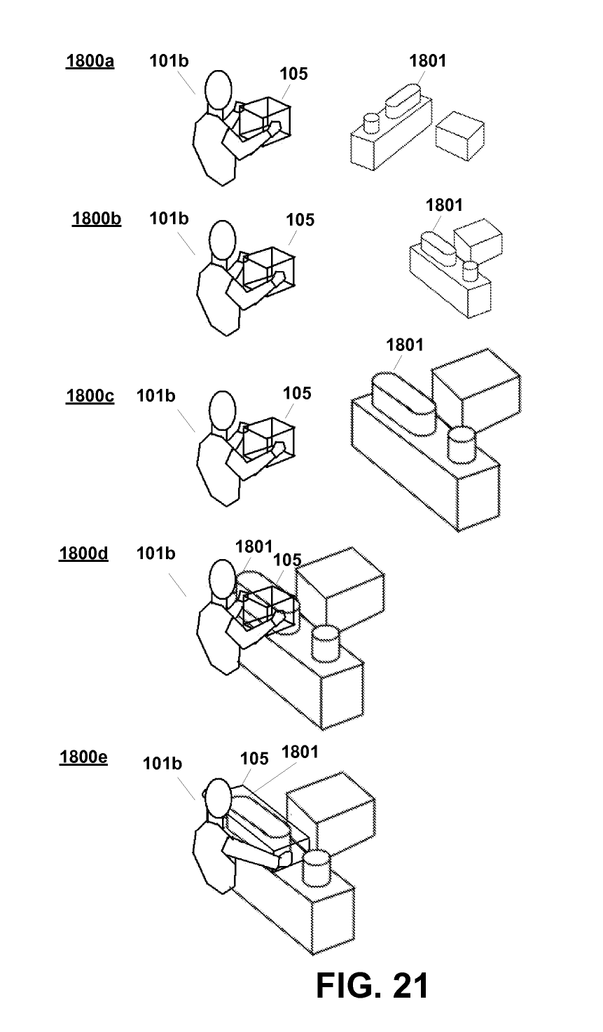

FIG. 21 illustrates various steps in a posture and approach maneuver as discussed above with respect to FIG. 20. For the convenience of explanation the user 101b is depicted conceptually as existing in the same virtual space of the object. One would of course understand that this is not literally true, and that the user simply has the perception of being in the environment, as well as of “holding” the VSO. In configuration 1800a the user is looking upon a three-dimensional environment which includes an object 1801 affixed to a larger body. User 101b has acquired VSO 105, possibly via a snap operation, and now wishes to inspect object 1801 using a rendering method described in greater detail below. Accordingly user 101b desires to place VSO 105 around the object 1801. Unfortunately, in the current configuration, the object is too small to be easily selected and is furthermore out of reach. The system is constrained not simply by the existing relative dimensions of the VSO and the objects in the three-dimensional environment, but also by the physical constraints of the user. A user can only separate their hands as far as the combined length of their arms. Similarly, a user cannot bring hand interfaces 102a-b arbitrarily closely together—eventually the devices collide. Accordingly, the user may perform various posture and approach techniques to select the desired object 1801.

In configuration 1800b, the user has performed a universal rotation to reorient the three-dimensional scene, such that the user 101b has easier access to object 1801. In configuration 1800c, the user has performed a universal scale so that the object 1801's dimensions are more commensurate with the user's physical hand constraints. Previously, the user would have had to precisely operate devices 102a-b within centimeters of one another to select object 1801 in the configurations 1800a or 1800b. Now they can maneuver the devices naturally, as though the object 1801 were within their physical, real-world grasp.

In configuration 1800d the user 101b performs a universal translation to bring the object 1801 within a comfortable range. Again, the user's physical constraints may prevent their reaching sufficiently far so as to place the VSO 105 around object 1801 in the configuration 1800c. In the hands of a skilled user one or more of translation, rotation, and scale may be performed simultaneously with a single gesture.

Finally, in configuration 1800e, the user may adjust the dimensions of the VSO 105 and place it around the object 1801, possibly using a snap-scale operation, a nudge, and/or a nudge-scale operation as discussed above. Although FIG. 20 illustrates the VSO 105 as being in user 101b's hands, one will readily recognize that the VSO 105 may not actually be attached to a cursor until a snap operation is performed. One will note, however, as is clear in configurations 1800a-c that when the user does hold the VSO it may be in the corner-face orientation, where the right hand is on the face and the left hand on a corner of the VSO 105 (as illustrated, although the alternative relationship may also readily be used as shown in other figures).

### Posture and Approach

### Example 2

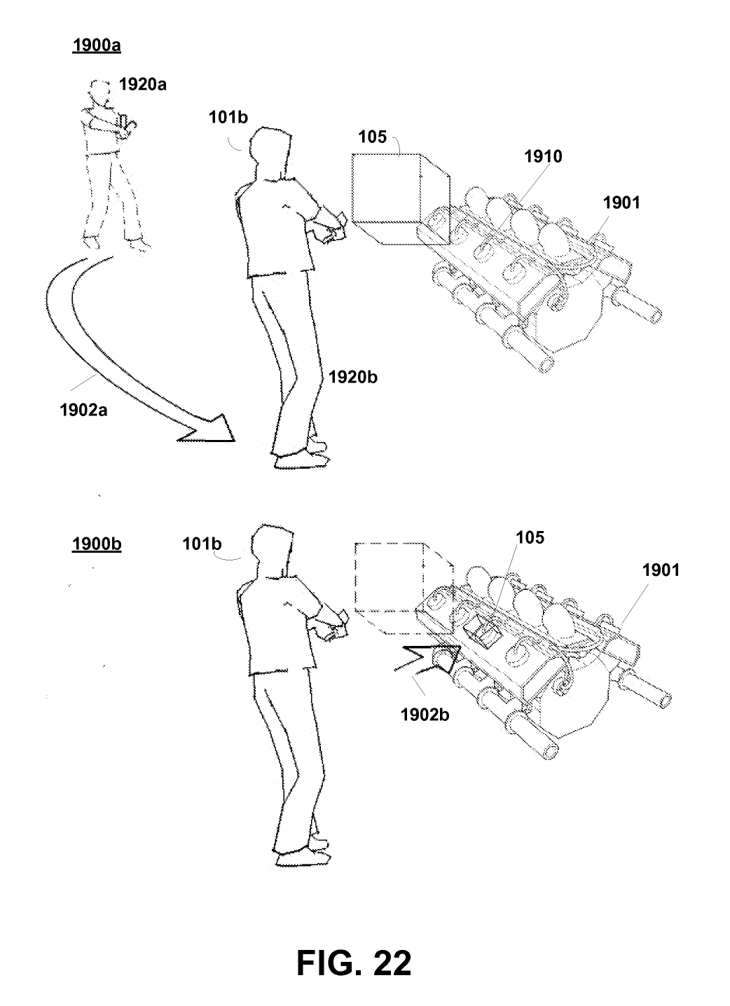

FIG. 22 provides another example of posture and approach maneuvering. In certain embodiments, the system facilitates simultaneous performance of the above-described operations. That is, the buttons on the hand interface 102a-b may be so configured such that a user may, for example, perform a universal scaling operation simultaneously with an object translation operation. Any combination of the above operations may be possible, and in the hands of an adept user, will facilitate rapid selection and navigation in the virtual environment that would be impossible with a traditional mouse-based system.

In configuration 1900a, a user 101b wishes to inspect a piston within engine 1901. The user couples a universal rotation operation with a universal translation operation to have the combined effect 1902a of reorienting themselves from the orientation 1920a to the orientation 1920b. The user 101b may then perform combined nudge and nudge-scale operations to position, orient, and scale VSO 105 about the piston via combined effect 1902b.

### Volumetric Rendering Methods

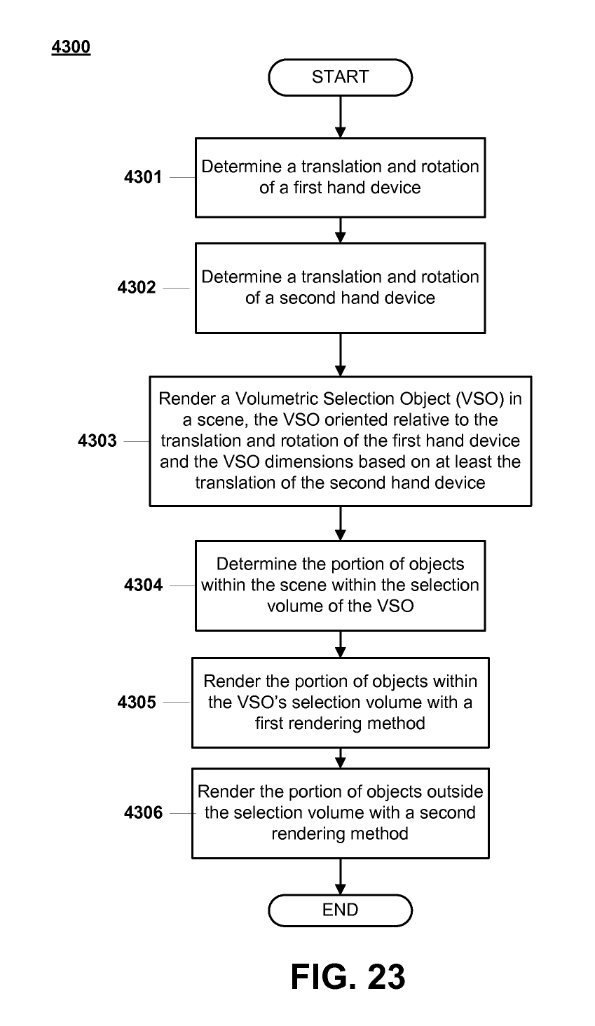

Once the VSO is positioned, oriented, and scaled as desired, the system may selectively render objects within the VSO selection volume to provide the user with detailed information. In some embodiments objects are rendered differently when the cursor enters the VSO. FIG. 23 provides a general overview of the selective rendering options. While a specific sequence of steps may be described herein with respect to FIG. 23, it will be recognized that same or similar functionality can also be achieved if the sequences of these acts is varied or carried out in a different order. The sequence of FIG. 23 is but one embodiment, and it will be recognized that the acts may be achieved in a different sequence, by removing certain acts, or adding certain acts.

The system may determine the translation and rotation of each of the hand interfaces at steps 4301 and 4302. As discussed above the VSO may be positioned, oriented, and scaled based upon the motion of the hand interfaces at step 4303. The system may determine the portions of objects that lie within the VSO selection volume at step 4304. These portions may then be rendered using a first rendering method at step 4305. At step 4306 the system may then render the remainder of the three-dimensional environment using the second rendering method.

Volumetric Rendering Example—Cutaway

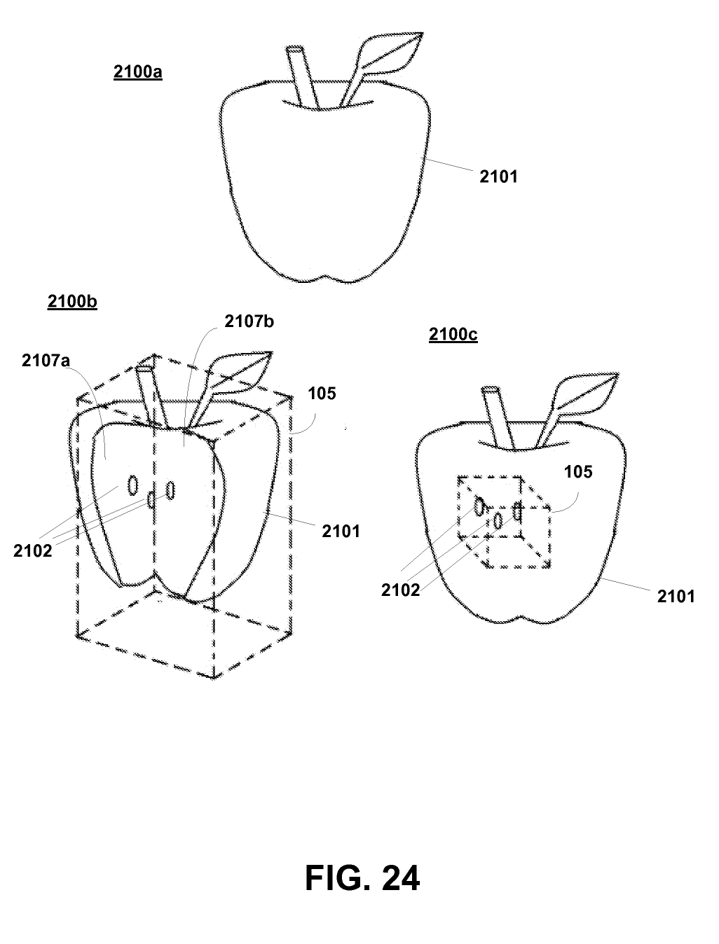

As one example of selective rendering, FIG. 24 illustrates a three-dimensional scene including a single apple 2101 in configuration 2100a. In configuration 2100b the VSO 105 is used to selectively “remove” a quarter of the apple 2101 to expose cross-sections of seeds 2102. In this example, everything within the VSO 105 is removed from the rendering pipeline and objects that would otherwise be occluded, such as seeds 2102 and the cross-sections 2107a-b are rendered.

Volumetric Rendering Example—Direct View

As another example of selective rendering, configuration 2100c illustrates a VSO being used to selectively render seeds 2102 within apple 2101. In this mode, the user is provided with a direct line of sight to objects within a larger object. Such internal objects, such as seeds 2102, may be distinguished based on one or more features of a dataset from which the scene is derived. For example, where the 3d-scene is rendered from volumetric data, the system may render voxels having a higher density than a specified threshold while rendering voxels with a lower density as transparent or translucent. In this manner, the user may quickly use the VSO to scan within an otherwise opaque region to find an object of interest.

Volumetric Rendering Example—Cross-Cut and Inverse

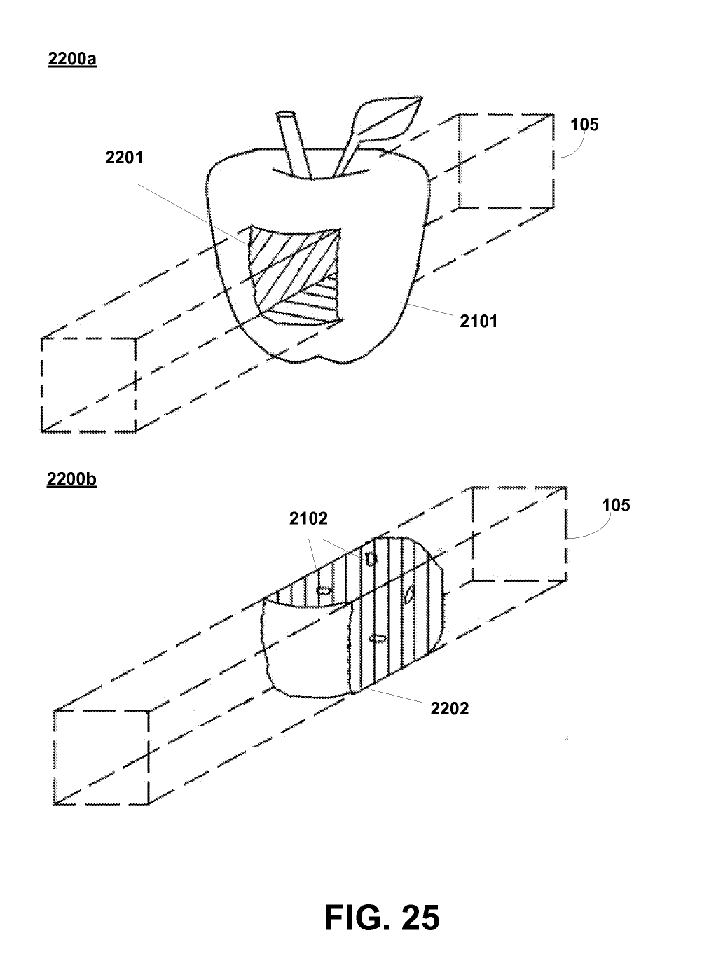

FIG. 25 illustrates two configurations 2200a and 2200b illustrating different selective rendering methods. In configuration 2200a, the removal method of configuration 2100b in FIG. 25 is used to selectively remove the interior 2201 of the apple 2101. In this manner, the user can use the VSO 105 to “see-through” objects.

Conversely, in configuration 2200b the rendering method is inverted, such that objects outside the VSO are not considered in the rendering pipeline. Again cross-sections 2102 of seeds are exposed.

In another useful situation, 3D imagery contained by the VSO is made to render invisibly. The user then uses the VSO to cut channels or cavities and pull him/herself inside these spaces, thus gaining easy vantage to the interiors of solid objects or dense regions. The user may choose to attach the VSO to his/her viewpoint to create a moving cavity within solid objects (Walking VSO). This is similar to a shaped near clipping plane. The Walking VSO may gradually transition from full transparency at the viewpoint to full scene density at some distance from the viewpoint. At times the user temporarily [symbol] releases the Walking VSO from his/her head, in order to take a closer look at the surrounding content.

### Immersive Volumetric Operations

Certain embodiments contemplate specific uses of the VSO to investigate within an object or a medium. In these embodiments, the user positions the VSO throughout a region to expose interesting content within the VSO's selection volume. Once located, the user may ‘go inside’ the VSO using the universal scaling and/or translation discussed above, to take a closer look at exposed details.

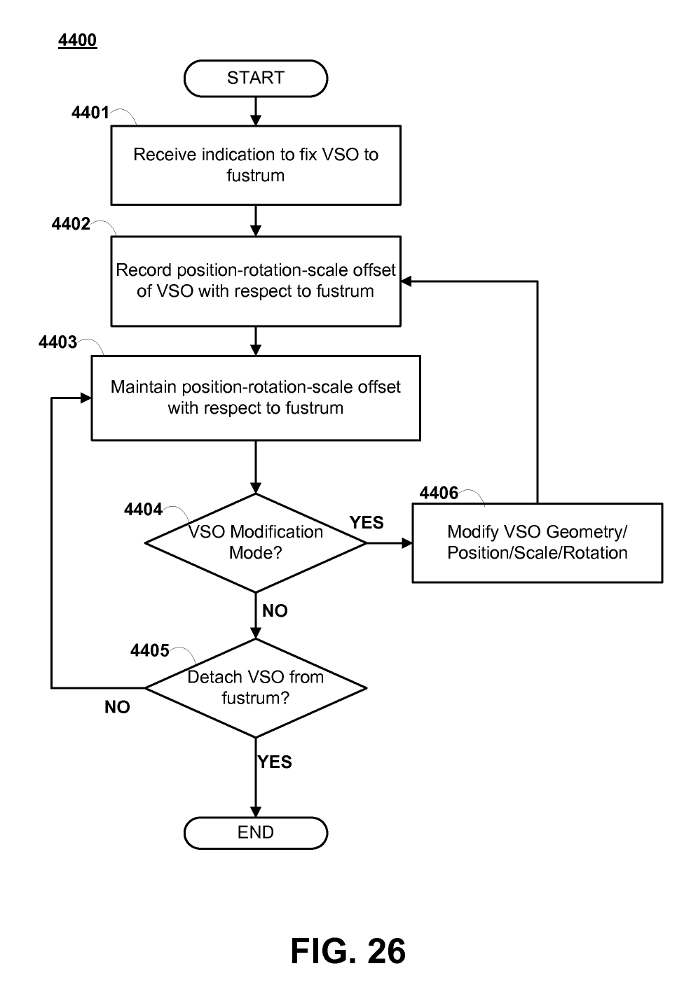

FIG. 26 is a flow diagram generally describing certain steps of this process. While a specific sequence of steps may be described herein with respect to FIG. 19, it will be recognized that same or similar functionality can also be achieved if the sequences of these acts is varied or carried out in a different order. The sequence of FIG. 19 is but one embodiment, and it will be recognized that the acts may be achieved in a different sequence, by removing certain acts, or adding certain acts.

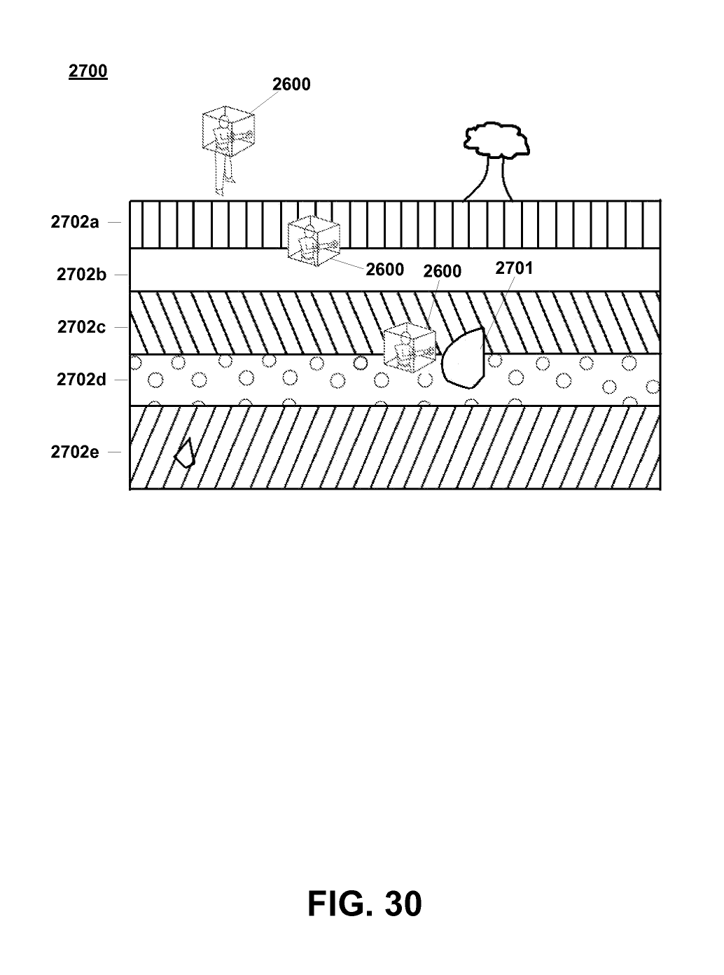

At step 4401, the system may receive an indication to fix the VSO to the viewing frustum. A step 4402 the system may then record one or more of the translation, rotation, and scale offset of the VSO with respect to the viewpoint of the viewing frustum. At step 4403 the system will maintain the offset with respect to the frustum, as the user maneuvers through the environment, as discussed below with regard to the example of FIG. 30.

Subsequently, at step 4404, the system may determine with the user wishes to modify the VSO while it is fixed to the viewing frustum. If so, the VSO may be modified at step 4406, such as by a nudge operation as discussed herein. Alternatively, the system may then determine if the VSO is to be detached from the viewing frustum at step 4405. If not, the system returns to state 4403 and continues operating, otherwise, the process comes to an end, with the system possibly returning to step 4401 or returning to a universal mode of operation.

Immersive Volumetric Operation Example—Partial Internal Clipping

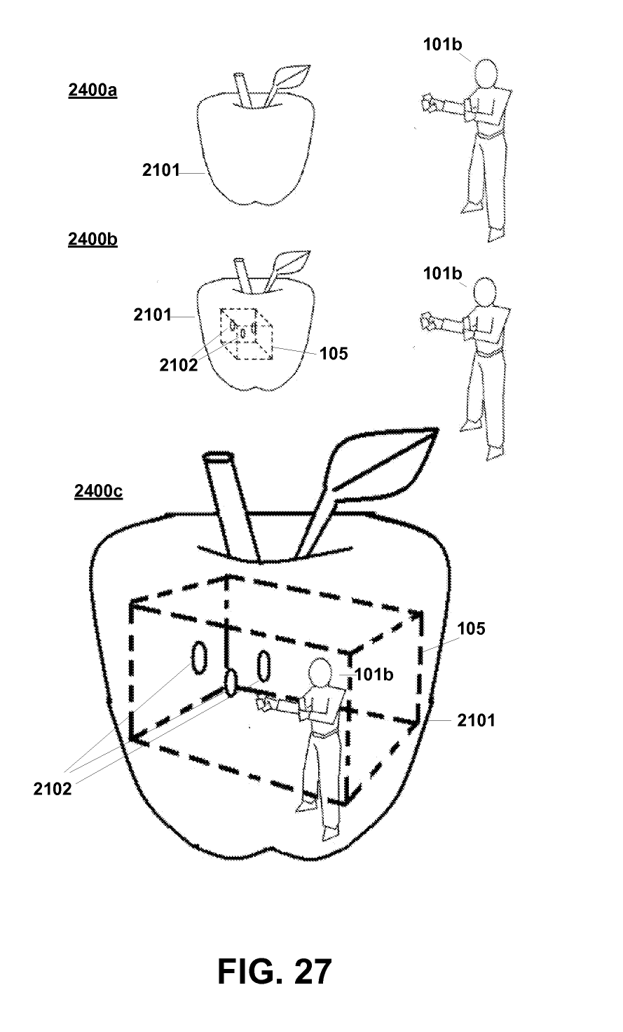

In FIG. 27 the user 101b wishes to inspect the seeds 2102 of apple 2101. In configuration 2400a, the user may place the VSO 105 within the apple 2101 and enable selective rendering as described in configuration 2100c of FIG. 24. In configuration 2400c the user may then perform a scale, rotation, and translate operation to place their viewing frustum within VSO 105 to thereby observe the seeds 2102 in detail. Further examples include specific density of CT scans, tagged objects from code or configuration, or selecting objects before placing the box around the volume.

Immersive Volumetric Operation Example—Complete Internal Clipping

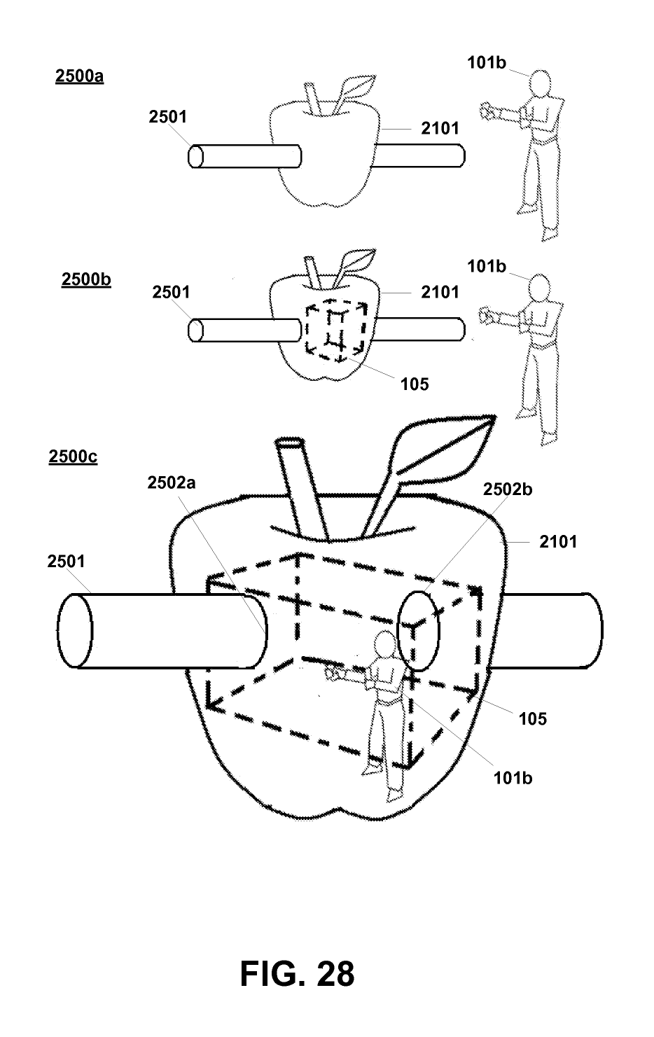

In FIG. 28 the apple 2101 is pierced through its center by a steel rod 2501. The user again wishes to enter apple 2101, but this time using the cross-section selective rendering method as in configuration 2100b of FIG. 24 so as to inspect the steel rod 2501. In configuration 2500c the user has again placed the VSO within the apple 2101 and entered the VSO via a scale and translation operation. However, using the selective rendering method of configuration 2100b, the seeds are no longer visible within the VSO. Instead, the user is able to view the interior walls of the apple 2101 and interior cross-sections 2502a and 2502b of the rod 2501.

User-Immersed VSO Clipping Volume

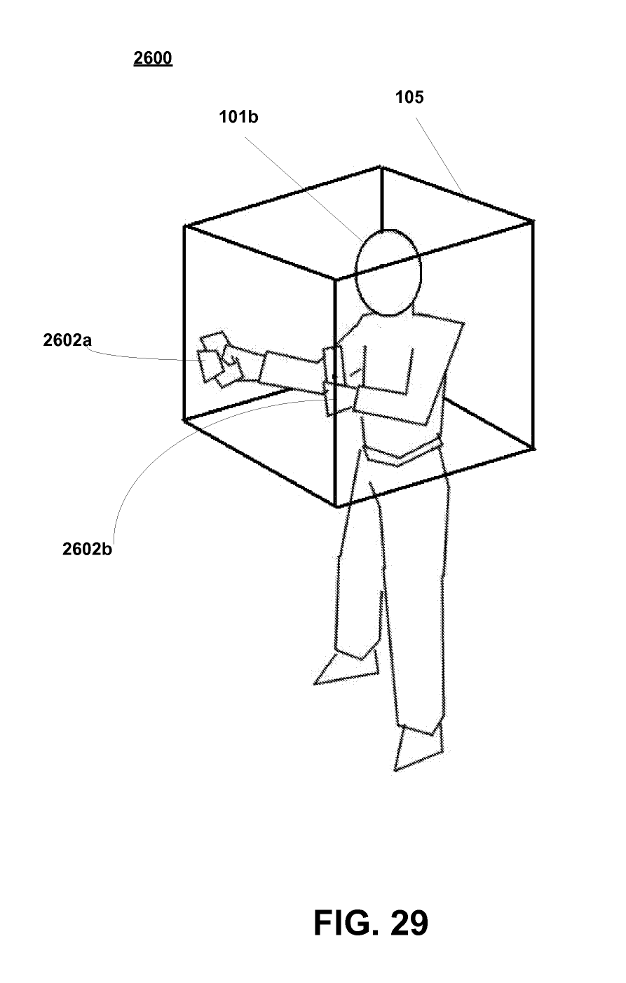

As mentioned above at step 4402 of FIG. 26, the user may wish to attach the VSO to the viewing frustum, possibly so that the VSO may be used to define a clipping volume within a dense medium. In this manner, the VSO will remain fixed relative to the viewpoint even during universal rotations/translations/scalings or rotations/translations/scalings of the frustum. This may be especially useful when the user is maneuvering within an object as in the example of configuration 2500c of FIG. 28. As illustrated in the conceptual configuration 2600 of FIG. 29, the user may wish to keep their hands 2602a-b (i.e., the cursors) within the VSO, so that the cursors 107a-b are rendered within the VSO. Otherwise, the cursors may not be visible if they are located beyond the VSO's bounds. This may be especially useful when navigating inside an opaque material which would otherwise occlude the cursors, preventing their providing feedback to the user which may be essential to navigate, as in the seismic dataset example presented below.

User-Fixed Clipping Example—Seismic Dataset

As another example of a situation where the user-fixed clipping may be helpful, FIG. 30 depicts a seismically generated dataset of mineral deposits. Each layer of sediment 2702a-b comprises a different degree of transparency correlated with seismic data regarding its density. The user in the fixed-clipping configuration 2600 wishes to locate and observe ore deposit 2701 from a variety of angles as it appears within the earth. Accordingly, the user may assume a fixed-clipping configuration 2600 and then perform posture and approach maneuvers through sediment 2702a-d until they are within viewing distance of the deposit 2701. If the user wished, they could then include the deposit within the VSO and perform the selective rendering of configuration 2100c to analyze the deposit 2701 in greater detail. By placing the cursors within the VSO, the user's ability to perform the posture and approach maneuvers is greatly facilitated.

Immersive Nudge Operation

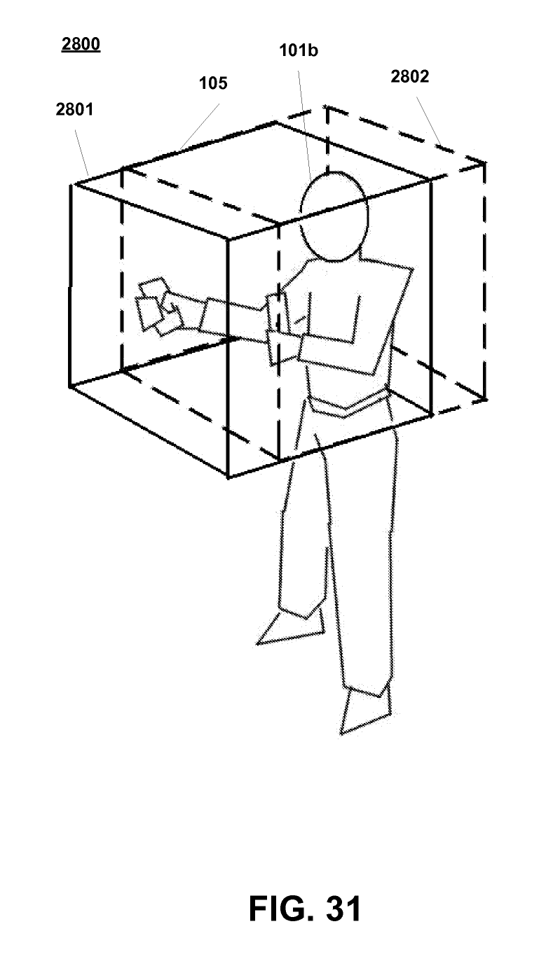

When the user is navigating to the ore deposit 2701 they may wish to adjust the VSO about the viewing frustum by very slight hand maneuvers. Attempting such an operation with a snap maneuver is difficult, as the user's hand would need to be placed outside of the VSO 105. Similarly, manipulating the VSO like an object in the universe may be impractical if rotations and scales are taken about its center. Accordingly, FIG. 31 depicts an operation referred to herein as an immersive nudge, wherein the user performs a nudge operation as described with respect to FIGS. 17 and 18, but wherein the deltas to a corner of the VSO from the cursor are taken from within the VSO. In this manner, the user may nudge the VSO from a first position 2802 to a second position 2801. This operation may be especially useful when the user is using the VSO to iterate through cross-sections of an object, such as ore deposit 2701 or rod 2501.

One use for going inside the VSO is to modify the VSO position, orientation, and scale from within. Consider the case above where the user has cut a cavity or channel e.g. in 3D medical imagery. This exposes interior structures such as internal blood vessels or masses. Once inside that space the user can nudge the position, orientation, and scale of the VSO from within to gain better access to these interior structures.

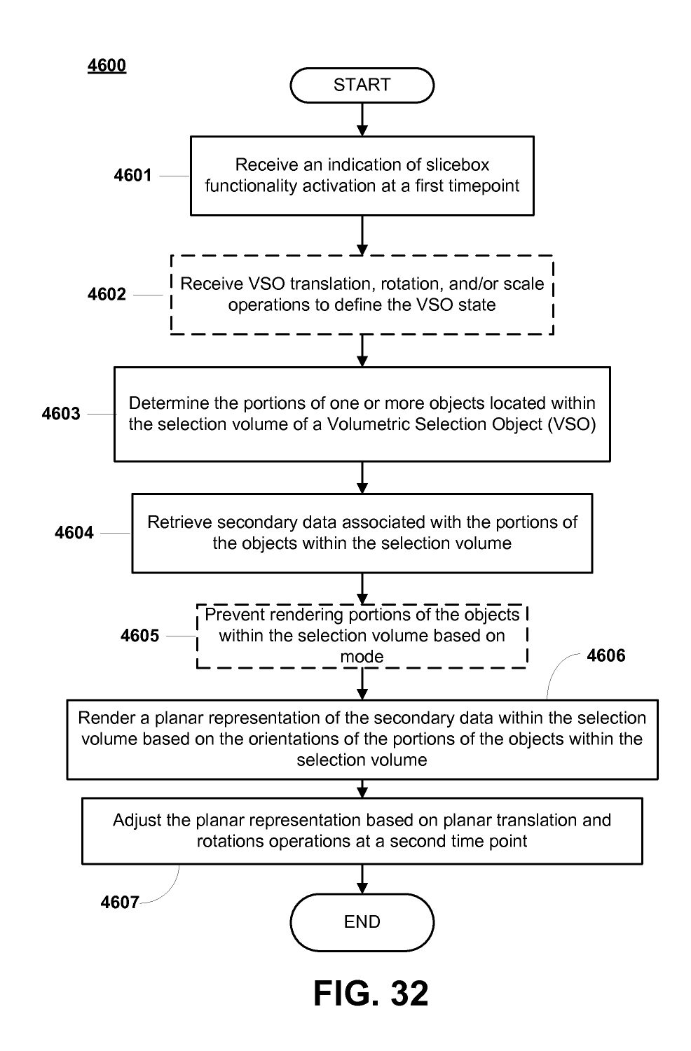

FIG. 32 is a flowchart depicting certain steps of the immersive nudge operation. At step 4601 the system receives an indication of nudge functionality from the user, such as when the user presses a button as described above. The system may then perform a VSO nudge operation at step 4602 using the methods described above, except that distances from the cursor to the corner of the VSO are determined while the cursor is within the VSO. If at steps 4603 and 4604, the system determines that the VSO is not operating as a VSO and the user's viewing frustum is not located within the VSO the process may end. However, if these conditions are present, the system may then recognize that an immersive nudge has been performed and may render the three-dimensional scene at step 4605 differently.

### Volumetric Slicing Volume Operation of the VSO

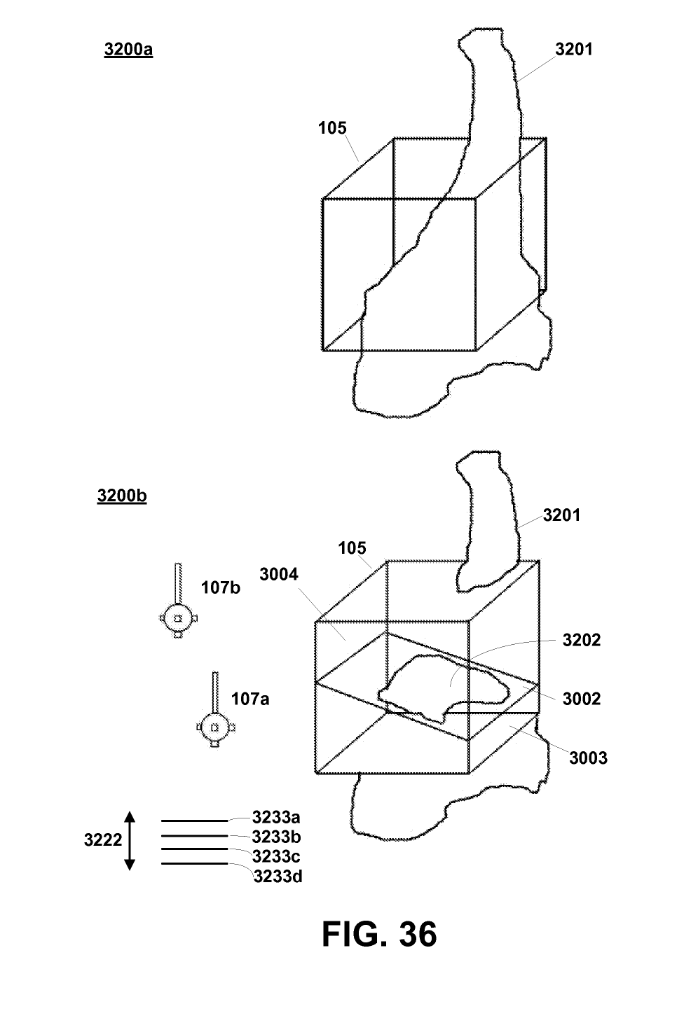

In addition to its uses for selective rendering and user position, orientation, and scale the VSO may also be coupled with secondary behavior to allow the user to define a context for that behavior. We describe a method for combining viewpoint and object manipulation techniques with the VSO volume specification/designation techniques for improved separation of regions and objects in a 3D scene. The result is a more accurate, efficient, and ergonomic VSO capability, that takes very few steps, and may reveal details of the data in 3D context. A slicing volume is a VSO which is depicting a secondary dataset within its interior. For example, as will be discussed in greater detail below, in FIG. 36 a user navigating a colon has chosen to investigate a sidewall structure 3201 using a VSO 105 operating as a slicing volume with a slice-plane 3002. The slice-plane 3002 depicts cross-sections of the sidewall structure using x-ray computed tomography (CT) scan data. In some examples, the secondary dataset may be the same as the primary dataset used to render objects in the universe, but objects within the slicing volume may be rendered differently.

FIG. 32 is a flow diagram depicting steps of a VSO's operation as a slicing volume. Once the user has positioned the VSO around a desired portion of an object in the three-dimensional environment, the user provides an indication to initiate slicing volume functionality at step 4601. The system may then take note of the translation and rotation of the interfaces at step 4602, as will be further described below, so that the slicing volume may be adjusted accordingly. At step 4603 the system will determine what objects, or portion of objects, within the environment fall within the VSO's selection volume. The system may then retrieve a secondary dataset at step 4604 associated with the portion of the objects within the selection volume. For example, if the system is analyzing a three-dimensional model of an organ in the human body for which a secondary dataset of CT scan information is available, the VSO may retrieve the portion of the CT scan information associated with the portion of the organ falling within the VSO selection volume.

At step 4605, as will be discussed in greater detail below, the system may then prevent rendering of certain portions of objects in the rendering pipeline so that the user may readily view the contents of the slicing volume. The system may then, at step 4606, render a planar representation of the secondary data within the VSO selection volume referred to herein as a slice-plane. This planar representation may then be adjusted via rotation and translation operations.

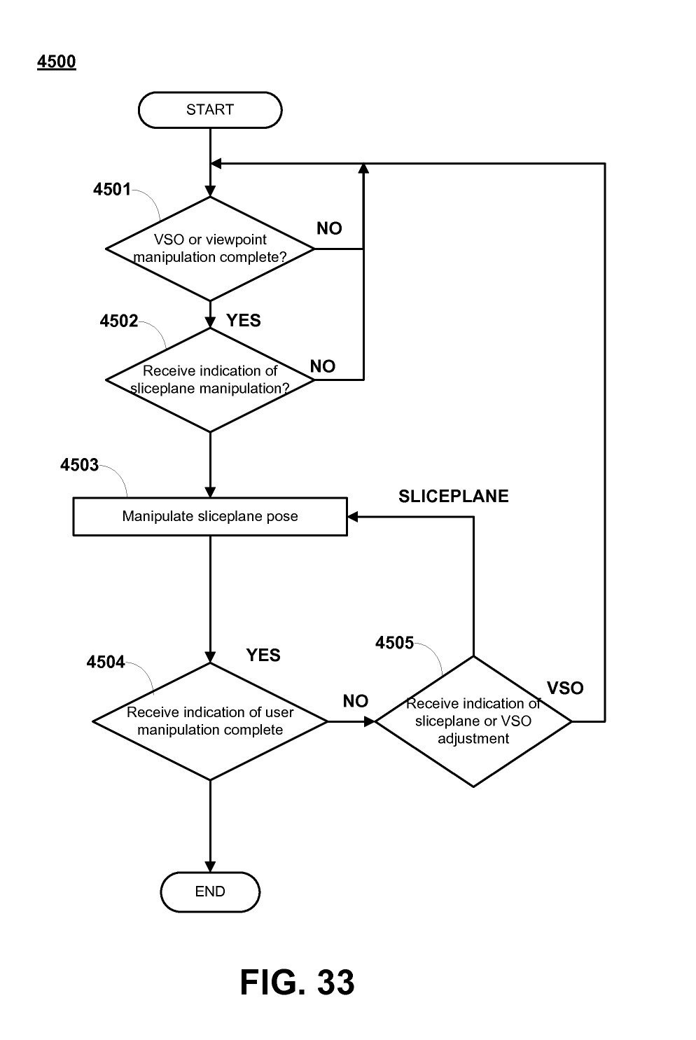

FIG. 33 is a flow diagram depicting certain behaviors of the system in response to user manipulations as part of the slicebox operation. At step 4501 the system may determine if the user has finished placing the VSO around an object of interest in the universe. Such an indication may be provided by the user clicking a button. If so, the system may then determine at step 4502 whether indication of a sliceplane manipulation has been received. For example, a button designated for sliceplane activation may be clicked by the user. If such an indication has been received, then the system may manipulate a sliceplane pose 4503 based on the user's gestures. One will recognize that a single indication may be used to satisfy both of the decisions at steps 4501 and 4502. Where the system does not receive an indication of the VSO manipulation or of sliceplane manipulation, the system may loop, waiting for steps 4501 and 4502 to be satisfied (such as when a computer system waits for one or more interrupts). At step 4504 the user may indicate that manipulation of the sliceplane is complete and the process will end. If not, the system will determine at step 4505 whether the user desires to continue adjustment of the sliceplane or VSO, and may transition to steps 4502 and 4501 respectively. Note that in certain embodiments, slicing volume and slice-plane manipulation could be accomplished with a mouse, or similar device, rather than with a two-handed interface.

Volumetric Slicing volume Operation—One-Handed Slice-Plane Position and Orientation

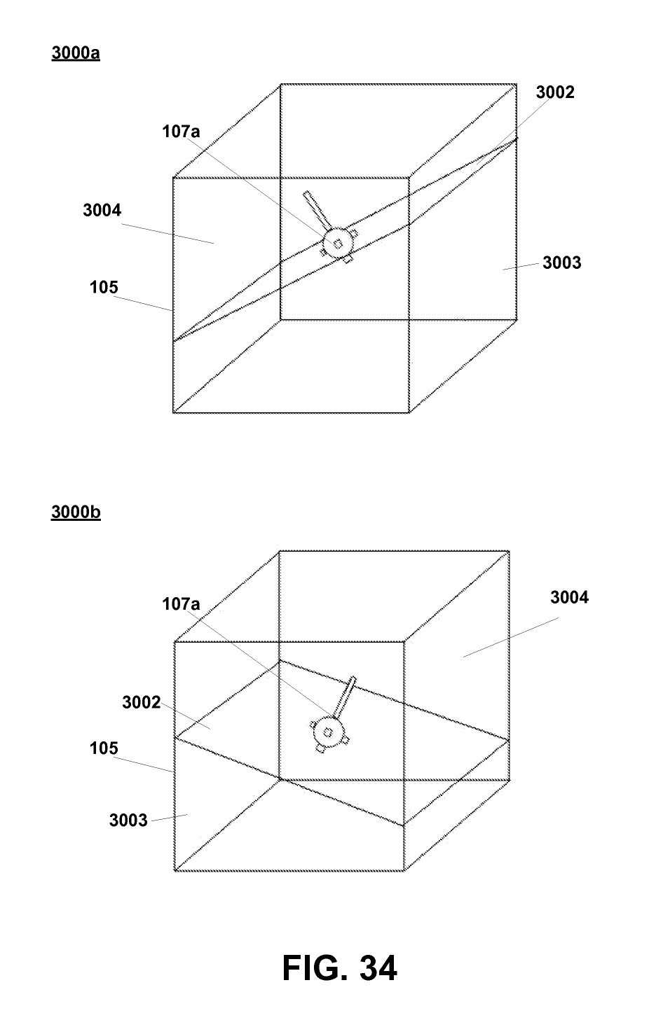

Manipulation of the slicing volume may be similar to, but not the same as general object manipulation in THI. Certain embodiments share a similar gesture vocabulary (grabbing, pushing, pulling, rotating, etc.) with which the user is familiar as part of normal VSO usage and posture and approach techniques, with the methods for manipulating the slice-plane of the slicing volume. An example of one-handed slice-plane manipulation is provided in FIG. 34. In configurations 3000a and 3000b, the position and orientation of the slice-plane 3002 tracks the position and orientation of the user's cursor 107a. As the user moves the hand holding the cursor up and down, or rotated, the slice plane 3002 is similarly raised and lowered, or rotated. In some embodiments, the location of the slice-plane not only determines where the planar representation of the secondary data is to be provided, but also where different rendering methods are to be applied in regions above 3004 and below 3003 the slice plane. In some embodiments, described below, the region 3003 below the sliceplane 3002 may be rendered more opaque to more clearly indicate where secondary data is being provided.

Volumetric Slicing volume Operation—Two-Handed Slice-Plane Position and Orientation

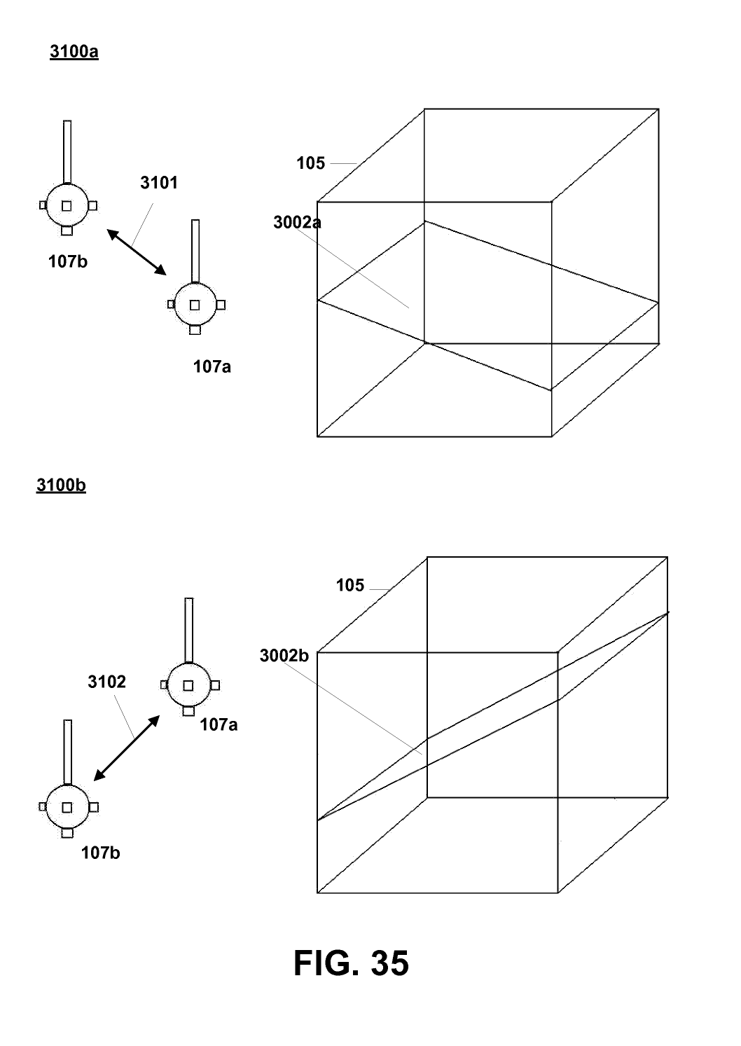

Another two-handed method for manipulating the position and orientation of the slice-plane 3002 is provided in FIG. 35. In this embodiment, the system determines the relative position and orientation 3101 of the left 107b and right 107a cursors including a midpoint therebetween. As the cursors rotate relative to one another about the midpoint the system adjusts the rotation of the sliceplane 3002 accordingly. That is, in configuration 3100a the position and orientation 3101 corresponds to the position and orientation of the sliceplane 3002a and in configuration 3100b the position and orientation 3102 corresponds to the orientation of the sliceplane 3002b. Similar to the above operations as the user moves one or both of their hands up and down, the sliceplane 3002 may similarly be raised or lowered.

Volumetric Slicing volume Operation Colonoscopy Example—Slice-Plane Rendering

An example of slicing volume operation is provided in FIG. 36. In this example, a three-dimensional model of a patient's colon is being inspected by a physician. Within the colon are folds of tissue 3201, such as may be found between small pouches within the colon known as haustra. A model of a patient's colon may identify both fecal matter and cancerous growth as a protrusion in these folds. As part of diagnosis a physician would like to distinguish between these protrusions. Thus, the physician may first identify the protrusion in the fold 3201 by inspection using an isosurface rendering of the three-dimensional scene. The physician may then confirm that the protrusion is or is not cancerous growth by corroborating this portion of the three-dimensional model with CT scan data also taken from the patient. Accordingly, the physician positions the VSO 105 as shown in configuration 3200a about the region of the fold of interest. The physician may then activate slicing volume functionality as shown in the configuration 3200b.

In this embodiment, the portion of the fold 3201 falling within the VSO selection area is not rendered in the rendering pipeline. Rather, a sliceplane 3002 is shown with a topographic data 3202 of the portion of the fold. One may recognize that a CT scan may acquire tomographic data in the vertical direction 3222. Accordingly, the secondary dataset of CT scan data may comprise a plurality of successive tomographic images acquired in the 3222 directions, such as at positions 3233a-c. The system may interpolate between these successive images to create a composite image 3202 to render onto the surface of the sliceplane 3002.

Volumetric Slicing volume Operation Colonoscopy Examples—Intersection and Opaque Rendering

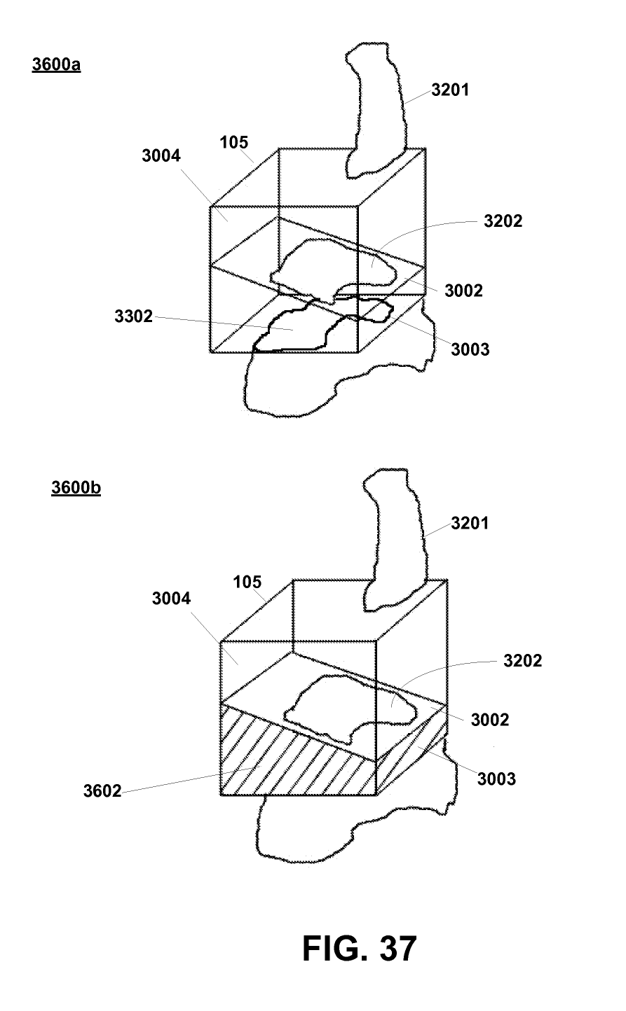

One will recognize that depending on the context and upon the secondary dataset in issue it may be beneficial to render the contents of the slicing volume in a plurality of techniques. FIG. 37 further illustrates certain slicing volume rendering techniques that may be applied. In configuration 3600a the system may render a cross-section 3302 of the object intersecting the VSO 105, rather than render an empty region or a translucent portion of the secondary dataset. Similarly, in configuration 3600b the system may render an opaque solid 3003 beneath the sliceplane 3602 to clearly indicate the level and orientation of the plane, as well as the remaining secondary data content available in the selection volume of the VSO. If the VSO extends into a region in which secondary data is unavailable, the system may render the region using a different solid than solid 3602.

Volumetric Slicing volume Operation Example—Transparency Rendering

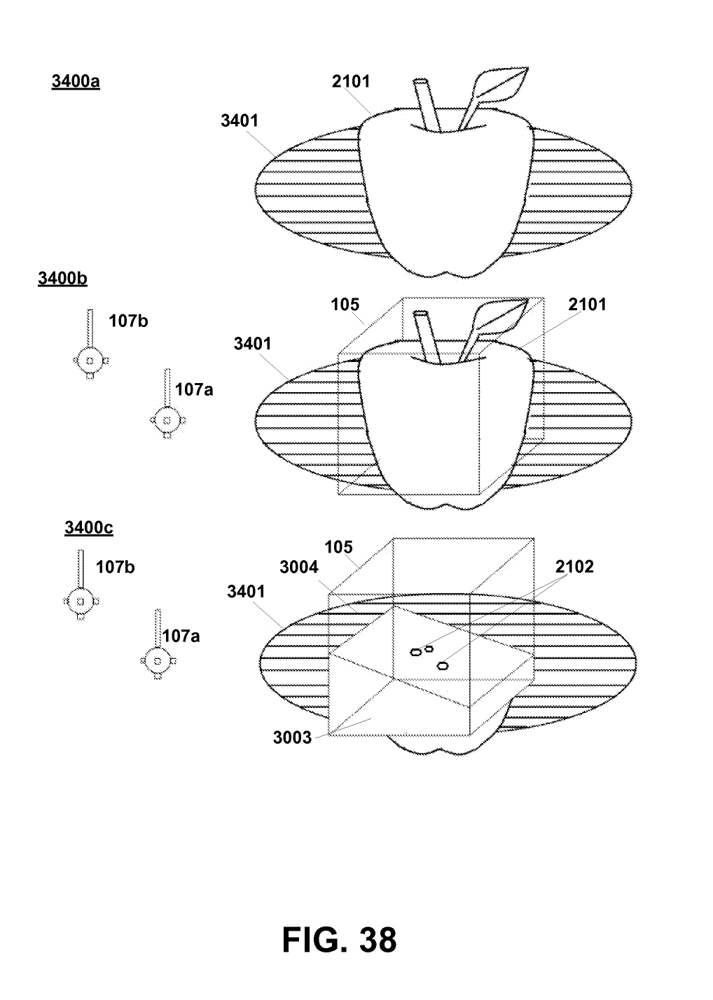

FIG. 38 provides another aspect of the rendering technique which may be applied to the slicing volume. Here, apple 2101 is to be analyzed using a slicing volume. In this example, the secondary dataset may comprise a tomographic scan of the apple's interior. Behind the apple is a scene which includes grating 3401. As illustrated in configuration 3400b, prior to activation of the VSO, the grating 3401 is rendered through the VSO 105 as in many of the above-discussed embodiments. In this embodiment of the slicing volume, however, in configuration 3400c, the grating is not visible through the lower portion 3003 of the slicing volume. This configuration allows a user to readily distinguish the content of the secondary data, such as seed cross-sections 2102, from the background scene 3401, while still providing the user with the context of the background scene 3401 in the region 3004 above the slicing volume.

### Remarks Regarding Terminology

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium may be coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

All of the processes described above may be embodied in, and fully automated via, software code modules executed by one or more general purpose or special purpose computers or processors. The code modules may be stored on any type of computer-readable medium or other computer storage device or collection of storage devices. Some or all of the methods may alternatively be embodied in specialized computer hardware.

All of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors or circuitry or collection of circuits, e.g. a module) that executes program instructions or modules stored in a memory or other non-transitory computer-readable storage medium. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

In one embodiment, the processes, systems, and methods illustrated above may be embodied in part or in whole in software that is running on a computing device. The functionality provided for in the components and modules of the computing device may comprise one or more components and/or modules. For example, the computing device may comprise multiple central processing units (CPUs) and a mass storage device, such as may be implemented in an array of servers.

In general, the word “module,” as used herein, refers to logic embodied in hardware or firmware, or to a collection of software instructions, possibly having entry and exit points, written in a programming language, such as, for example, Java, C or C++, or the like. A software module may be compiled and linked into an executable program, installed in a dynamic link library, or may be written in an interpreted programming language such as, for example, BASIC, Perl, Lua, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

All of the methods and processes described above may be embodied in, and fully automated via, software code modules executed by one or more general purpose computers or processors. The code modules may be stored in any type of computer-readable medium or other computer storage device. Some or all of the methods may alternatively be embodied in specialized computer hardware.

Each computer system or computing device may be implemented using one or more physical computers, processors, embedded devices, field programmable gate arrays (FPGAs), or computer systems or portions thereof. The instructions executed by the computer system or computing device may also be read in from a computer-readable medium. The computer-readable medium may be non-transitory, such as a CD, DVD, optical or magnetic disk, laserdisc, flash memory, or any other medium that is readable by the computer system or device. In some embodiments, hardwired circuitry may be used in place of or in combination with software instructions executed by the processor. Communication among modules, systems, devices, and elements may be over a direct or switched connections, and wired or wireless networks or connections, via directly connected wires, or any other appropriate communication mechanism. Transmission of information may be performed on the hardware layer using any appropriate system, device, or protocol, including those related to or utilizing Firewire, PCI, PCI express, CardBus, USB, CAN, SCSI, IDA, RS232, RS422, RS485, 802.11, etc. The communication among modules, systems, devices, and elements may include handshaking, notifications, coordination, encapsulation, encryption, headers, such as routing or error detecting headers, or any other appropriate communication protocol or attribute. Communication may also messages related to HTTP, HTTPS, FTP, TCP, IP, ebMS OASIS/ebXML, DICOM, DICOS, secure sockets, VPN, encrypted or unencrypted pipes, MIME, SMTP, MIME Multipart/Related Content-type, SQL, etc.

Any appropriate 3D graphics processing may be used for displaying or rendering, including processing based on OpenGL, Direct3D, Java 3D, etc. Whole, partial, or modified 3D graphics packages may also be used, such packages including 3DS Max, SolidWorks, Maya, Form Z, Cybermotion 3D, VTK, Slicer, Blender or any others. In some embodiments, various parts of the needed rendering may occur on traditional or specialized graphics hardware. The rendering may also occur on the general CPU, on programmable hardware, on a separate processor, be distributed over multiple processors, over multiple dedicated graphics cards, or using any other appropriate combination of hardware or technique. In some embodiments the computer system may operate a Windows operating system and employ a GFORCE GTX 580 graphics card manufactured by NVIDIA, or the like.

As will be apparent, the features and attributes of the specific embodiments disclosed above may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Any process descriptions, elements, or blocks in the processes, methods, and flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

All of the methods and processes described above may be embodied in, and fully automated via, software code modules executed by one or more general purpose computers or processors, such as those computer systems described above. The code modules may be stored in any type of computer-readable medium or other computer storage device. Some or all of the methods may alternatively be embodied in specialized computer hardware.

It should be emphasized that many variations and modifications may be made to the above-described embodiments, the elements of which are to be understood as being among other acceptable examples. All such modifications and variations are intended to be included herein within the scope of this disclosure and protected by the following claims.

While inventive aspects have been discussed in terms of certain embodiments, it should be appreciated that the inventive aspects are not so limited. The embodiments are explained herein by way of example, and there are numerous modifications, variations and other embodiments that may be employed that would still be within the scope of the present disclosure.

What is claimed is:

1. A method for repositioning, reorienting, and rescaling a visual selection object (VSO) within a three-dimensional scene, the method comprising:
receiving an indication of nudge functionality activation at a first timepoint;
determining a first position and orientation offset between the VSO and a first cursor,
receiving a change in position and orientation associated with the first cursor's first position and orientation and its second position and orientation; and
translate and rotate the VSO relative to the first cursor such that:
the VSO maintains the first offset relative position and relative orientation to the first cursor in the second orientation as in the first orientation,
wherein the method is implemented on one or more computer systems.

2. The method of claim 1, wherein determining a first element of the VSO comprises determining an element closest to the first cursor.

3. The method of claim 1, wherein the element of the VSO comprises one of a vertex, face, or edge of the VSO.

4. The method of claim 1, further comprising:
receiving an indication to perform a scaling operation;
determining a second offset between a second element of the VSO and a second cursor; and
scaling the VSO about the first element maintaining the second offset between the second element of the VSO and the position of the second cursor.

5. The method of claim 4, wherein the second offset comprises a zero or non-zero distance.

6. The method of claim 4, wherein the second element comprises a vertex and scaling the VSO based on the second offset and a position of the second cursor comprises modifying the contours of the VSO in each of three dimensions based on the second cursor's translation from a first position to a second position.

7. The method of claim 4, wherein the second element comprises an edge and scaling the VSO based on the second offset and a position of the second cursor comprises modifying the contours of the VSO in the directions that are orthogonal to the direction of the edge based on the second cursor's translation from a first position to a second position.

8. The method of claim 4, wherein the second element comprises a face and scaling the VSO based on the second offset comprises modifying the contours of the VSO in the direction orthogonal to the element based on the second cursor's translation from a first position to a second position.

9. The method of claim 4, further comprising:
receiving an indication to terminate the scaling operation;
receiving a change in translation and rotation associated with the first cursor from the second position and orientation to a third position and orientation; and
maintaining the first offset relative direction and relative rotation to the first cursor in the third position and orientation as in the first position and orientation.

10. The method of claim 1, wherein a viewpoint of a viewing frustum is located within the VSO, the method further comprising adjusting a rendering pipeline based on the position and orientation and dimensions of the VSO.

11. The method of claim 10, wherein the dimensions of the VSO facilitate full extension of a user's arms without cursors corresponding to hand interfaces in the user's left and right hands leaving the selection volume of the VSO.

12. The method of claim 1, wherein determining a first offset between a first element of the VSO and a first cursor comprises receiving an indication from the user selecting the first element of the VSO from a plurality of elements associated with the VSO.

13. A non-transitory computer-readable medium comprising instructions configured to cause one or more computer systems to perform the method comprising:
receiving an indication of nudge functionality activation at a first timepoint;
determining a first position and orientation offset between the VSO and a first cursor,
receiving a change in position and orientation associated with the first cursor's first position and orientation and its second position and orientation; and
translating and rotating the VSO relative to the first cursor such that:
the VSO maintains the first offset relative position and relative orientation to the first cursor in the second orientation as in the first orientation.

14. The non-transitory computer-readable medium of claim 13, wherein determining a first element of the VSO comprises determining an element closest to the first cursor.

15. The non-transitory computer-readable medium of claim 13, wherein the element of the VSO comprises one of a vertex, face, or edge of the VSO.

16. The non-transitory computer-readable medium of claim 13, the method further comprising:
receiving an indication to perform a scaling operation;
determining a second offset between the element of the VSO and a second cursor; and
scaling the VSO based on the second offset and a position of the second cursor.

17. The non-transitory computer-readable medium of claim 16, wherein the second offset comprises a zero or non-zero distance.

18. The non-transitory computer-readable medium of claim 16, wherein the second element comprises a vertex and scaling the VSO based on the second offset and a position of the second cursor comprises modifying the contours of the VSO in each of three dimensions based on the second cursor's translation from a first position to a second position.

19. The non-transitory computer-readable medium of claim 16, wherein the second element comprises an edge and scaling the VSO based on the second offset and a position of the second cursor comprises modifying the contours of the VSO in directions that are orthogonal to the direction of the edge based on the second cursor's translation from a first position to a second position.

20. The non-transitory computer-readable medium of claim 16, wherein the second element comprises a face and scaling the VSO based on the second offset comprises modifying the contours of the VSO in a direction orthogonal to the face based on the second cursor's translation from a first position to a second position.

21. The non-transitory computer-readable medium of claim 16, the method further comprising:
receiving an indication to terminate the scaling operation;
receiving a change in translation and rotation associated with the first cursor from the second position and orientation to a third position and orientation; and
maintaining the first offset relative direction and relative rotation to the first cursor in the third position and orientation as in the first position and orientation.

22. The non-transitory computer-readable medium of claim 13, wherein determining a first offset between a first element of the VSO and a first cursor comprises receiving an indication from the user selecting the first element of the VSO from a plurality of elements associated with the VSO.

23. The non-transitory computer-readable medium of claim 13, wherein a viewpoint of a viewing frustum is located within the VSO, method further comprising adjusting a rendering pipeline based on the orientation and dimensions of the VSO.

24. The non-transitory computer-readable medium of claim 23, wherein adjusting a rendering pipeline comprises removing portions of objects within the selection volume of the VSO from the rendering pipeline.

25. The non-transitory computer-readable medium of claim 23, wherein the dimensions of the VSO facilitate full extension of a user's arms without cursors corresponding to hand interfaces in the user's left and right hands leaving the selection volume of the VSO.
